(19) United States
(12) Patent Application Publication
(10) Pub. No.: US 2026/0149229 A1
(43) Pub. Date: May 28, 2026

(54) SYSTEM AND METHOD FOR RESETTING SMART SOCKET SETTINGS TO DEFAULT VALUES

(71) Applicant: Honeywell International Inc., Charlotte, NC (US)

(72) Inventors: Bo Fang, Tianjin (CN); Di Lin, Tianjin (CN); Jixiang Yu, Tianjin (CN); Jiajia Xu, Tianjin (CN)

(21) Appl. No.: 19/122,550

(22) PCT Filed: Oct. 28, 2022
(86) PCT No.: PCT/CN2022/128109

§ 371 Date: Apr. 18, 2025

(51) Int. Cl. H01R 13/70; H01R 13/717; H01R 25/00; H01R 105/00

(52) U.S. Cl. CPC H01R 13/70; H01R 13/7175; H01R 25/006; H01R 2105/00

(57) ABSTRACT

A smart socket includes one or more socket receptacles, one or more power connections, and a power input port for receiving input power from the one or more power connections. The smart socket includes one or more receptacle switches. The smart socket includes one or more receptacle switch buttons that, when manually pressed by a user, causes the corresponding receptible switch to alternately switch between the open position and the closed position. The smart socket includes a controller having a non-volatile memory for storing one or more smart socket settings that each can be changed from a default value to a programmed value. The controller monitors manual presses of the one or more receptacle switch buttons, and in response to detecting a predetermined sequence of button presses, resets at least some of the one or more smart socket settings to their corresponding default values.

The present application claims priority to PCT International Application No. PCT/CN2022/128109, filed on Oct. 28, 2022, entitled “SYSTEM AND METHOD FOR RESETTING SMART SOCKET SETTINGS TO DEFAULT VALUES”, which is incorporated herein by reference.

### TECHNICAL FIELD

The present disclosure relates generally to smart sockets, and more particularly to smart sockets that provide a reset function to factory defaults.

### BACKGROUND

Smart sockets provide power to a variety of different devices that are plugged into a smart socket. Smart sockets can include circuitry that allows a user to remotely control the smart socket to control whether the smart socket provides power to a device that is connected to a receptacle of the smart socket. Smart sockets may include a number of programmable parameters that need to be configured. Smart sockets may become inappropriately configured for a particular application, and it may be desirable to return to the factory default configuration. Thus, it would be desirable to have smart sockets that provide an easy way to reset the smart socket to a factory default configuration while minimizing unintended resets.

### SUMMARY

The present disclosure relates generally to smart sockets, and more particularly to smart sockets that provide a reset function to factory defaults. An example may be found in a smart socket that includes a housing that houses one or more socket receptacles each for receiving an electrical plug, one or more power connections for connecting to a power source, and a power input port for receiving input power from the one or more power connections. The housing houses one or more receptacle switches each operatively coupled between the power input port and a corresponding socket receptacle. Each receptacle switch, when in a closed position, allows power to pass from the power input port to the corresponding socket receptacle, and when in an open position, does not allow power to pass from the power input port to the corresponding socket receptacle. The housing houses one or more receptacle switch buttons accessible from outside of the housing, wherein each of the one or more receptacle switch buttons, when manually pressed by a user, causes the corresponding receptible switch to alternately switch between the open position and the closed position (sometimes subject to an override from a controller of the smart socket). The housing houses a meter for capturing one or more electrical characteristics of power that is delivered to each of the one or more socket receptacles, a wireless communication circuit for wirelessly communicating with a remote device, and a controller operatively coupled to the one or more receptacle switches, the meter and the wireless communication circuit. The controller is configured to receive from the meter one or more of the captured electrical characteristics of the power that is delivered to each of the one or more socket receptacles, transmit via the wireless communication circuit one or more power parameters that are based at least in part on one or more of the received electrical characteristics of the power that is delivered to the one or more socket receptacles, and receive one or more commands via the wireless communication circuit, including a command that causes the controller to switch one or more of the receptacle switches between the closed position and the open position. The controller further includes a non-volatile memory for storing one or more smart socket settings that each can be changed from a default value to a programmed value, wherein the controller references the one or more smart socket settings to control one or more operations of the smart socket. The controller is configured to monitor manual presses of the one or more receptacle switch buttons, and in response to detecting a predetermined sequence of two or more manual presses of the one or more receptacle switch buttons, resets at least some of the one or more smart socket settings to their corresponding default values.

Another example may be found in a smart socket that includes a housing that houses one or more socket receptacles each for receiving an electrical plug, one or more power connections for connecting to a power source, a power input port for receiving input power from the one or more power connections, and one or more receptacle switches each operatively coupled between the power input port and a corresponding socket receptacle. Each receptacle switch, when in a closed position, allows power to pass from the power input port to the corresponding socket receptacle, and when in an open position, does not allow power to pass from the power input port to the corresponding socket receptacle. The housing houses one or more receptacle switch buttons accessible from outside of the housing, wherein each of the one or more receptacle switch buttons, when manually pressed by a user causes the corresponding receptible switch to alternately switch between the open position and the closed position (sometimes subject to an override from a controller of the smart socket). The housing houses a wireless communication circuit for wirelessly communicating with a remote device, and a controller operatively coupled to the one or more receptacle switches and the wireless communication circuit. The controller is configured to receive one or more commands via the wireless communication circuit, including a command that causes the controller to switch one or more of the receptacle switches between the closed position and the open position. The controller further includes one or more smart socket settings that each can be changed from a default value to a programmed value, wherein the controller references the one or more smart socket settings to control one or more operations of the smart socket. The controller is configured to monitor manual presses of the one or more receptacle switch buttons, and in response to detecting a predetermined sequence of two or more manual presses of the one or more receptacle switch buttons, resets at least some of the one or more smart socket settings to their corresponding default values.

Another example may be found in a method for resetting one or more smart socket settings of a smart socket, wherein each of the smart socket settings can be changed from a default value to a programmed value. The smart socket includes two or more socket receptacles each for receiving an electrical plug, two or more power connections for connecting to a power source, a power input port for receiving input power from the one or more power connections, and two or more receptacle switches each operatively coupled between the power input port and a corresponding socket receptacle. Each receptacle switch, when in a closed position, allows power to pass from the power input port to the corresponding socket receptacle, and when in an open position, does not allow power to pass from the power input port to the corresponding socket receptacle. The smart socket further includes two or more receptacle switch buttons, wherein each of the two or more receptacle switch buttons, when manually pressed by a user causes the corresponding receptible switch to alternately switch between the open position and the closed position (sometimes subject to an override from a controller of the smart socket). The method includes monitoring manual presses of the two or more receptacle switch buttons. In response to detecting a predetermined sequence of two or more manual presses of the two or more receptacle switch buttons, at least some of one or more smart socket settings are reset to their corresponding default value.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram of an illustrative mesh system;

FIG. 2 is a schematic block diagram of an illustrative mesh system;

FIG. 3 is a schematic block diagram of an illustrative mesh system;

FIG. 4 is a schematic block diagram of an illustrative smart socket;

FIG. 5 is a flow diagram showing an illustrative method for testing a power line network of a building;

FIG. 6 is a front perspective view of an illustrative smart socket;

FIG. 7 is a back perspective view of the illustrative smart socket of FIG. 6;

FIG. 8 is a flow diagram showing an illustrative method for resetting a smart socket;

FIG. 9A is a flow diagram showing an illustrative method for resetting a smart socket;

FIG. 9B is a flow diagram showing an illustrative method for resetting a smart socket;

FIGS. 10A, 10B and 10C are flow diagrams that together show an illustrative method for maintaining communication between a supervisor and a plurality of Internet of Things (IoT) devices;

FIGS. 11A, 11B and 11C are flow diagrams that together show an illustrative method for maintaining communication between a supervisor and a plurality of Internet of Things (IoT) devices;

FIG. 12 is a schematic view of an illustrative emergency communication scenario within a mesh network;

FIG. 13 is a schematic view of an illustrative gateway replacement scenario within a mesh network;

FIG. 14A is a flow diagram showing an illustrative method;

FIG. 14B is a flow diagram showing an illustrative method;

FIG. 15 is a flow diagram showing an illustrative method;

FIGS. 16A and 16B are flow diagrams that together show an illustrative method for identifying a probable location of a device within a mesh network;

FIG. 17 is a flow diagram showing an illustrative method for confirming connectivity of a device within a mesh network;

FIG. 18 is a schematic view of an illustrative scenario of looking for a device within a mesh network;

FIG. 19 is a schematic view of an illustrative scenario of confirming the functioning of a device within a mesh network;

FIG. 20 is a schematic view of an illustrative scenario of ascertaining a probable location of a device within a mesh network;

FIG. 21 is a flow diagram showing an illustrative method;

FIG. 22 is a flow diagram showing an illustrative method;

FIG. 23 is a flow diagram showing an illustrative method;

FIG. 24 is a flow diagram showing an illustrative method; and

FIG. 25 is a screen shot showing an illustrative dashboard.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranged by endpoints includes all numbers subsumed within that range (e.g., 1 to 5 includes, 1, 1.5, 2, 2.75, 3, 3.8, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

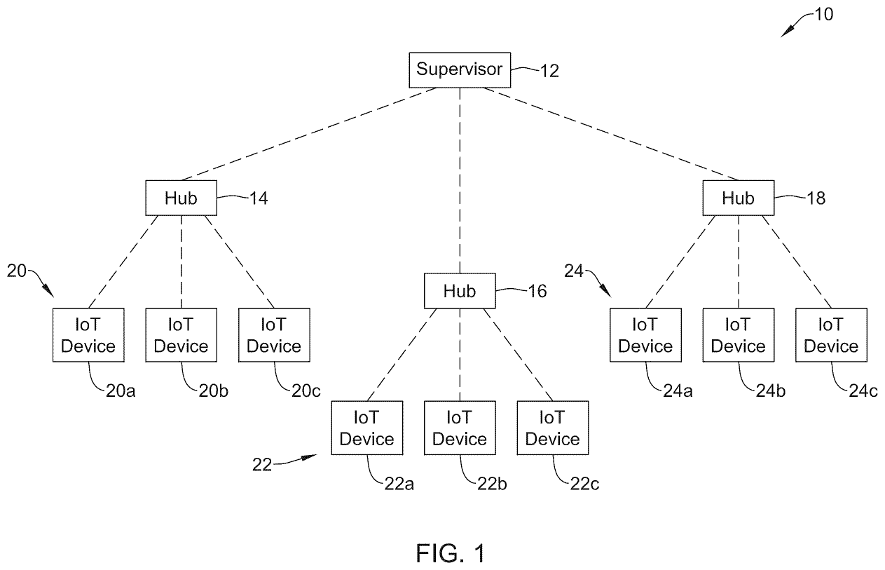

FIG. 1 is a schematic block diagram showing an illustrative system 10. The illustrative system 10 includes a supervisor 12, a first gateway hub 14, a second gateway hub 16 and a third gateway hub 18. While a total of three gateway hubs 14, 16 and 18 are shown, it will be appreciated that this is merely illustrative, as the system 10 may include any number of gateway hubs. The system 10 includes a number of IoT (Internet of Things) devices, divided into a first group of IoT devices 20, a second group of IoT devices 22 and a third group of IoT devices 24. The IoT devices within the first group of IoT devices 20 are individually labeled as 20a, 20b and 20c. The IoT devices within the second group of IoT devices 22 are individually labeled as 22a, 22b and 22c. The IoT devices within the third group of IoT devices 24 are individually labeled as 24a, 24b and 24c. This is merely illustrative, as the first group of IoT devices 20, the second group of IoT devices 22 and/or the third group of IoT devices 24 may each include any number of IoT devices, and in some cases may include a substantially larger number of IoT devices.

Each of the IoT devices 20, the IoT devices 22 and the IoT devices 24 may independently be any of a variety of different IoT devices. In general, IoT devices are physical objects having sensors, processing ability, software and/or other technologies that allow the devices to connect with and exchange data with other devices and systems over the Internet and/or other communication networks. IoT devices can include home automation devices, elder care devices, medical devices, transportation devices, vehicle to vehicle communication devices, building automation devices, industrial devices, maritime devices, infrastructure devices, energy management devices, environmental monitoring devices, and others. In some cases, a smart socket may be considered as being an example of an IoT device. A smart socket is an electrical receptacle that provides power to a device that is plugged into the electrical receptacle. In some cases, a smart socket includes circuitry that is able to monitor various aspects of the power being provided to the device, as well as communications circuitry that allows the smart socket to report those power aspects to another device such as a gateway hub. In some cases, a smart socket can include circuitry that allows a user to remotely control the smart socket to control whether the smart socket provides power to a device that is connected to a receptacle of the smart socket. These are just examples.

In some instances, the first group of IoT devices 20 and the first gateway hub 14 may together be considered as forming a first wireless mesh network, the second group of IoT devices 22 and the second gateway hub 16 may together be considered as forming a second wireless mesh network, and the third group of IoT devices 24 and the third gateway hub 18 may together be considered as forming a third wireless mesh network. The devices within the first wireless mesh network communicate in normal circumstances with only the other devices within the first wireless mesh network. The devices within the second wireless mesh network communicate in normal circumstances with only the other devices within the second wireless mesh network. The devices within the third wireless mesh network communicate in normal circumstances with only the other devices within the third wireless mesh network. In some instances, as will be discussed, communication breakdowns may cause devices within one wireless mesh network to attempt to communicate with devices within a neighboring wireless mesh network in order to maintain communication.

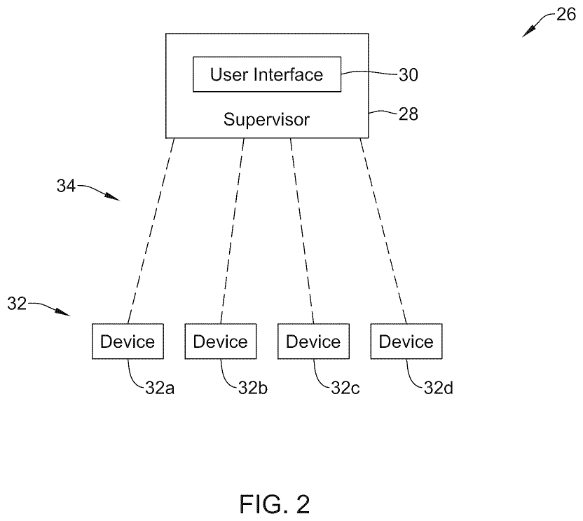

FIG. 2 is a schematic block diagram showing an illustrative system 26. The illustrative system 26 may be considered as being an example of the system 10, and vice versa. The system 26 includes a supervisor 28. The supervisor 28 may be manifested as an application executing a computer such as a computer server and/or a smartphone. The supervisor 28 includes a user interface 30. In some cases, the user interface 30 may be a display for displaying information. In some cases, the user interface 30 may include a data entry device such as a keyboard, mouse, trackball or electronic writing surface. In some cases, the user interface 30 may include a touch screen that functions as a display as well as providing data entry functionality.

The illustrative system 26 includes a number of devices 32 that are operatively coupled in a mesh network 34. The devices 32 are individually labeled as 32a, 32b, 32c and 32d. While a total of four devices 32 are shown, it will be appreciated that this is merely illustrative, as the system 26 may include any number of devices 32, and in some cases may include a substantially greater number of devices 32. In some cases, some of the devices 32 may represent gateway hubs. In some cases, at least some of the devices 32 may be IoT devices. These are just examples. In some cases, there may be a desire to be able to locate a particular one of the devices 32. Some of the devices 32 may be small, or may be obscured by furniture, for example.

In some cases, the supervisor 28 may be configured to cause the user interface 30 to display a device identifier for each of one or more of the devices 32, and may accept from a user a selection of which device 32 the user wishes to find. Once the user selects a selected device 32, the supervisor 28 sends a “find device” message to the selected device 32 (e.g. to the address of the selected device). In response, the selected device 32 is configured to receive the “find device” message and to identify a device identifier of each of one or more neighboring devices 32 that are in communication with the selected device 32 via the mesh network. The selected device 32 is configured to identify a signal strength value associated with each of the one or more neighboring devices 32 and to send a response message to the supervisor 28 that includes the device identifier and the associated signal strength value for each of at least one of the neighboring devices 32. In response to receiving the response message, the supervisor 28 is configured to determine a probable physical location of the selected device 32 based at least in part on the device identifier and the associated signal strength value for each of at least one of the neighboring devices 32 included in the response message. The supervisor 28 may be configured to communicate the probable physical location to a user. The supervisor 28 may use the known location of one or more of the neighboring devices to determine the probable physical location of the selected device 32. In some cases, the probable physical location of the selected device 32 may be expressed as being in proximity to a particular one of the neighboring devices 32 (e.g. near neighboring Device X), as being in a particular room of a building (e.g. in the lunch room) particularly when the physical location of at least some of the neighboring devices 32 are known), as being in a particular region expressed using a coordinate system such as GPS), and/or expressed in any other suitable manner.

In some cases, the response message may be sent to the supervisor 28 through one or more routing devices of the plurality of devices 32 of the mesh network 34, and each of the one or more routing devices may add its device identifier to the response message. In some cases, the supervisor 28 may be configured to determine the probable physical location of the selected device 32 based at least in part on the device identifier and the associated signal strength value for each of at least one of the neighboring devices 32 included in the response message, and at least one of the device identifiers of the one or more routing devices added to the response message.

In some cases, the selected device 32 may be configured to activate a visual and/or audible alert of the selected device 32 in response to receiving the find device message. This may include the selected device 32 illuminating a light, for example, and/or outputting an audible sound. The selected device 32 may be configured to receive a user input from the user via the user interface 30 of the supervisor, or optionally a user interface of the selected device 32 indicating that the selected device 32 has been found by the user, and in response, deactivate the visual and/or audible alert of the selected device 32.

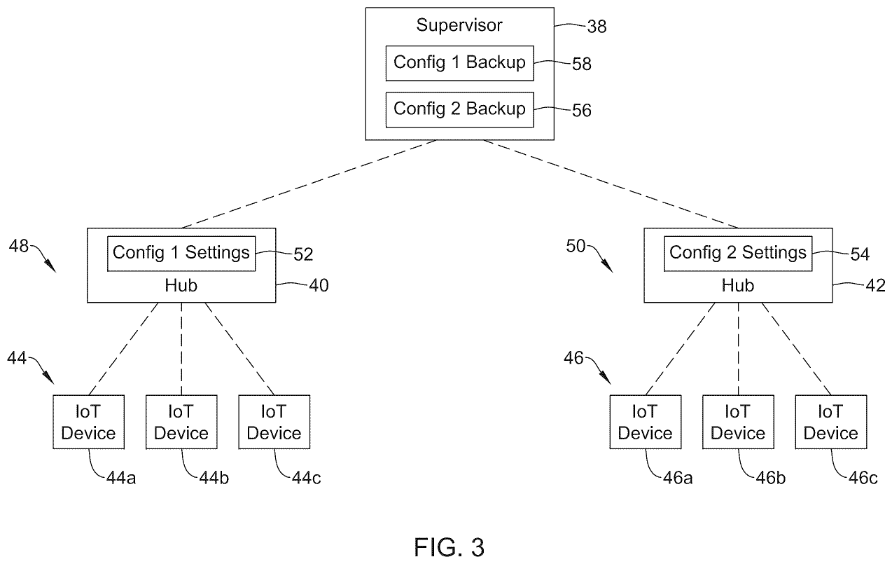

FIG. 3 is a schematic block diagram of an illustrative system 36. The illustrative system 36 may be considered as being an example of the system 10 and/or the system 26, and vice versa. The illustrative system 36 includes a supervisor 38, a first gateway hub 40 and a second gateway hub 42. In some cases, the system 36 may include additional gateway hubs. The system 36 includes a number of IoT devices that are arranged into a first group of IoT devices 44, individually labeled as 44a, 44b and 44c and a second group of IoT devices 46, individually labeled as 46a, 46b and 46c. This is merely illustrative, as there may be any number of IoT devices 44 and 46. The first group of IoT devices 44 and the first gateway hub 40 together form a first wireless mesh network 48. The second group of IoT devices 46 and the second gateway hub 42 together form a second wireless mesh network 500. The first gateway hub 40 is in communication with the supervisor 38 and provides communication between the supervisor 38 and the first group of IoT devices 44. The second gateway hub 42 is in communication with the supervisor 38 and provides communication between the supervisor 38 and the second group of IoT devices 46.

In some cases, the first gateway hub 40 stores Config1 Settings 52 that includes device identifiers that identify each of the first group of IoT devices 44. In some cases, the second gateway hub 52 stores Config2 Settings 54 that includes device identifiers that identify each of the second group of IoT devices 46. The supervisor 38 is configured to back up the Config1 Settings 52 and the Config2 Settings 54, as evidenced by a Config1 Backup 56 and a Config2 Backup 58. The Config1 Backup 56 backs up the configuration settings within the Config1 Settings 52 while the Config2 Backup 58 backs up the configuration settings within the Config2 settings 54. In some cases, the supervisor 38 is configured to back up the Config1 Settings 52 and the Config2 Settings 54 periodically, such as once per hour, once per day, once per week, etc. In some cases, the supervisor 38 is configured to back up the Config1 Settings 52 and the Config2 Settings 54 each time the Config1 Settings 52 and/or the Config2 Settings 54 change. These are just examples.

In some cases, the supervisor 38 is configured to determine that the second gateway hub 42 has failed such that each of the second group of IoT devices 46 go offline relative to the supervisor 38. In response to determining that the second gateway hub 42 has failed, the supervisor 38 is configured to communicate at least some of the configuration settings of the second gateway hub 42 to the first gateway hub 40, including communicating the device identifiers that identify each of the second group of IoT devices 46.

After receiving the device identifiers that identify each of the second group of IoT devices 46, the first gateway hub 40 is configured to instruct each of the first group of IoT devices 44 to initiate an emergency communication channel and to search for the first group of IoT devices 46 that are identified by the device identifiers that were communicated to the first gateway hub 40 from the supervisor 38. The first group of IoT devices 44 are configured to establish communication via the emergency communication channel with one or more of the second group of IoT devices 46 that were identified by the device identifiers communicated to the first gateway hub 40, resulting in one or more of the offline IoT devices 46 of the second group of IoT devices 46 becoming online IoT devices relative to the supervisor 38 through the first gateway hub 40. In some cases, each of the IoT devices 46 of the second group of IoT devices 46 that become online IoT devices relative to the supervisor 38 through the first gateway hub 40 are configured to search for other of the IoT devices 46 of the second group of IoT devices 46 that are still offline, and when found, establish communication via the emergency communication channel (or the mesh network) with the found IoT devices 46 of the second group of IoT devices 46.

In some cases, after the second gateway hub 42 has been replaced with a replacement second gateway hub, the supervisor 38 is configured to communicate at least some of the configuration settings of the second gateway hub 42 to the replacement second gateway hub, including communicating the device identifiers that identify each of the second group of IoT devices 46. The first gateway hub 40 may be configured to instruct each of the first group of IoT devices 44 to deactivate the emergency communication channel, causing each of the second group of IoT devices 46 to go offline. The replacement second gateway hub is configured to establish communication with each of the second group of IoT devices 46 identified by the device identifiers that were communicated to the replacement second gateway hub from the supervisor 38.

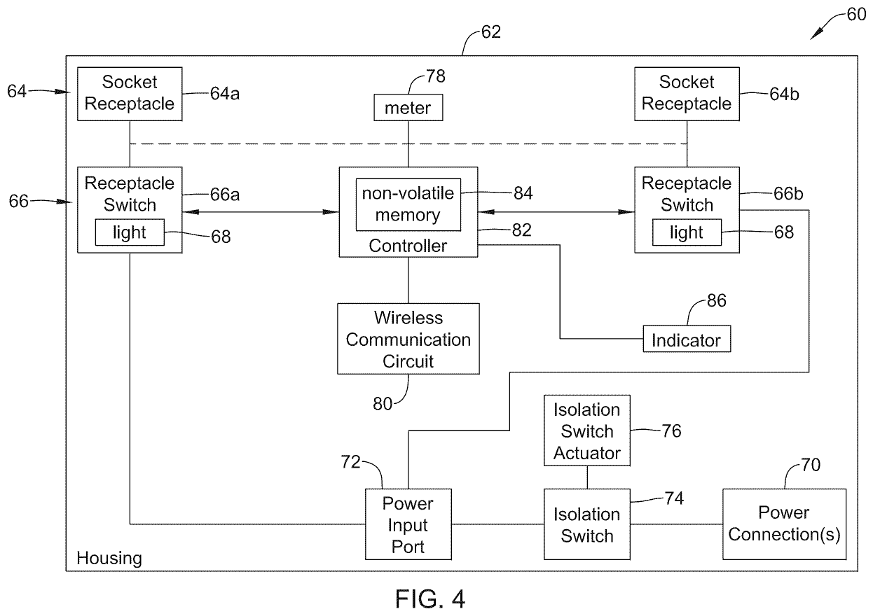

FIG. 4 is a schematic block diagram of an illustrative smart socket 60. The illustrative smart socket 60 may be considered as being an example of an IoT device such as the IoT devices 20, 22, 24, 44 and 46, or more generically the devices 32. The illustrative smart socket 60 includes a housing 62. As shown, the housing 62 houses a number of components of the smart socket 60, although some components of the smart socket 60 may be considered as being accessible from a position exterior to the housing 62. The illustrative smart socket 60 includes socket receptacles 64, individually labeled as 64a and 64b. The socket receptacles 64 are each configured to receive an electrical plug. While a pair of socket receptacles 64 are shown, in some cases the smart socket 60 may include only one socket receptacle 64. In some cases, the smart socket 60 may include three or more socket receptacles 64.

The illustrative smart socket 60 includes several receptacle switches 66, individually labeled as 66a and 66b. While two receptacle switches 66 are shown, in some cases, there may be only one receptacle switch 66 or three or more receptacle switches 66. In some cases, there will be one receptacle switch 66 for each receptacle socket 64. In some cases, each of the receptacle switches 66 may include a light 68 such as but not limited to an LED. The light 68 may be used to indicate whether power is turned on to a corresponding receptacle socket 64, for example. In some cases, the lights 68 may be used in a reset process, as will be discussed.

The illustrative smart socket 60 includes one or more power connection(s) 70 for connecting to a power source (not shown). In some cases, the power connection(s) 70 may include a live connection, a neutral connection and a ground connection. The power connection(s) 70 may include one or more wiring terminals for connecting to power line wires. The power connection(s) 70 may additionally or alternatively include one or more wires. A power input port 72 is configured to receive input power from the power connection(s) 70.

The illustrative smart socket 60 includes an isolation switch 74 that is electrically coupled between the power connection(s) 70 and the power input port 72. The isolation switch 74, when in a closed position, allows power to pass from the power connection(s) 70 to the power input port 72, and when in an open position, does not allow power to pass from the power connection(s) 70 to the power input port 72 thereby isolating the power input port 72 from the power source. In some cases, the smart socket 60 includes an isolation switch actuator 76 that is accessible from outside of the housing 62, wherein the isolation switch actuator 76 is manually movable by a user to manually switch the isolation switch 74 between the closed position and the open position.

Each of the receptacle switches 66 are operatively coupled between the power input port 72 and the corresponding socket receptacle 64. When in a closed position, the receptacle switch 66 allows power to pass from the power input port 72 to the corresponding socket receptacle 64. When in an open position, the receptacle switch 66 does not allow power to pass from the power input port 72 to the corresponding socket receptacle 64. In some cases, the corresponding light 68 may indicate that power is being allowed to flow to the corresponding socket receptacle 64. For example, the light 68 may glow green to indicate the flow of power, and may glow red (or be off) in order to indicate that no power is flowing to the socket receptacle 64. In some cases, each of the receptacle switches 66a, 66b can be manually switched by a user. In some cases, the each of the receptacle switches 66a, 66b can be switched by the controller 82 based on instructions received from a user via the wireless communication circuit 80. In some cases, each of the receptacle switches 66a, 66b may be electronically controlled by the controller 82, using input signals from manual push buttons associated with each of the receptacle switches 66a, 66b on the illustrative smart socket 60. When so provided, the controller 82 may prevent power from being delivered to a socket receptacle 64 even when the manual push button associated with the socket receptacle 64 is pushed by a user. That is, the controller 82 may lock a particular socket receptacle 64 and prevent a user from manually activating the socket receptacle 64 by pushing the push button that is associated with the socket receptacle 64. In some cases, the controller 82 may lock one or more socket receptacle 64 based on a programmed schedule.

The illustrative smart socket 60 includes a meter 78 that is configured to capture one or more electrical characteristics of power that is delivered to each socket receptacle 64. A wireless communication circuit 80 is configured for wireless communicating with a remote device such as a mesh network, a gateway hub, a mobile device or another IoT device, for example. A controller 82 is operatively coupled with each receptacle switch 66, the meter 78 and the wireless communication circuit 80. The controller 82 is configured to receive from the meter 78 one or more of the captured electrical characteristics of the power that is delivered to the corresponding socket receptacle 64 and to transmit via the wireless communication circuit 80 one or more power parameters that are based at least in part on one or more of the received electrical characteristics of the power that is delivered to the socket receptacle 64. The controller 82 is configured to receive one or more commands via the wireless communication circuit 80, including a command that causes the controller 82 to switch the appropriate receptacle switch 66 between the closed position and the open position.

In some cases, at least some of the receptacle switches 66 include a relay, and the controller 82 may be configured to switch the receptacle switch 66 by controlling the relay. In some instances, the controller 82 may be operably coupled to the isolation switch 74. The controller 82 may be configured to receive one or more commands via the wireless communication circuit 80 including a command that causes the controller 82 to switch the isolation switch 74 between the closed position and the open position. As an example, the isolation switch 74 may include a latching relay, and the controller 82 may be configured to switch the isolation switch 74 by controlling the latching relay.

In some cases, the controller 82 includes a non-volatile memory 84 that is configured for storing one or more smart socket settings that each can be changed from a default value to a programmed value, wherein the controller 82 references the one or more smart socket settings to control one or more operations of the smart socket 60. The controller 82 may be configured to monitor manual presses of the receptacle switches 66, and in response to detecting a predetermined sequence of two or more manual presses of receptacle switches 66, the controller 82 may reset at least some of the one or more smart socket settings to their corresponding default values.

As noted, each of the receptacle switches 66 includes a light 68. The light 68 may represent a single light or a plurality of lights, for example. The light 68 is visible from outside of the housing 62. In some cases, the controller 82 is configured to control the illumination of the lights 68. In some cases, the controller 82 controls the illumination of each of the lights 68 in a manner that confirms each of the manual presses of the predetermined sequence of two or more manual presses. In some cases, detecting the predetermined sequence of two or more manual presses of the one or more receptacle switches 66 includes detecting a manual press and hold of one of the receptacle switches 66 for at least a predetermined press and hold time period. In some cases, detecting the predetermined sequence of two or more manual presses of the one or more receptacle switches 66 includes detecting a manual press occurring within a predetermined time window after a triggering event. The triggering event may include a manual press and release of one of the receptacle switches 66. In some cases, the triggering event may include providing input power to the power input port 72 after a time of not providing input power to the power input port 72.

In some cases, the predetermined sequence of two or more manual presses may include a manual press of a first one of the two or more receptacle switches 66 and a manual press of a second one of the two or more receptacle switches 66. As another example, the predetermined sequence of two or more manual presses may include a manual press of the first one of the two or more receptacle switches 66 followed by a manual press of the second one of the two or more receptacle switches 66 within a predetermined time window following the manual press of the first one of the two or more receptacle switches 66. As another example, the predetermined sequence of two or more manual presses may include a manual press and hold of the first one of the two or more receptacle switches 66 for at least a predetermined press and hold time period, followed by a manual press of the second one of the two or more receptacle switches 66 within a predetermined time window following the manual press and hold of the first one of the two or more receptacle switches 66. As another example, the predetermined sequence of two or more manual presses may include a manual press of the first one of the two or more receptacle switches 66 followed by another manual press of the first one of the two or more receptacle switches 66.

In some cases, the smart socket 60 may include an indicator 86 that is operably coupled to and controlled by the controller 82. The indicator 86 may be configured to provide a visual indicator. The indicator 86 may be configured to provide an audio indicator. In some cases, the indicator 86 may provide both simultaneously, such as by lighting a light and sounding a buzzer, for example. The indicator 86 may be used by the controller 82 in situations in which a user is attempting to locate the particular smart socket 60. In some cases, the power connection(s) 70 include a live connection and a neutral connection, and the isolation switch 74 is electrically coupled between the live connection and the power input port 72.

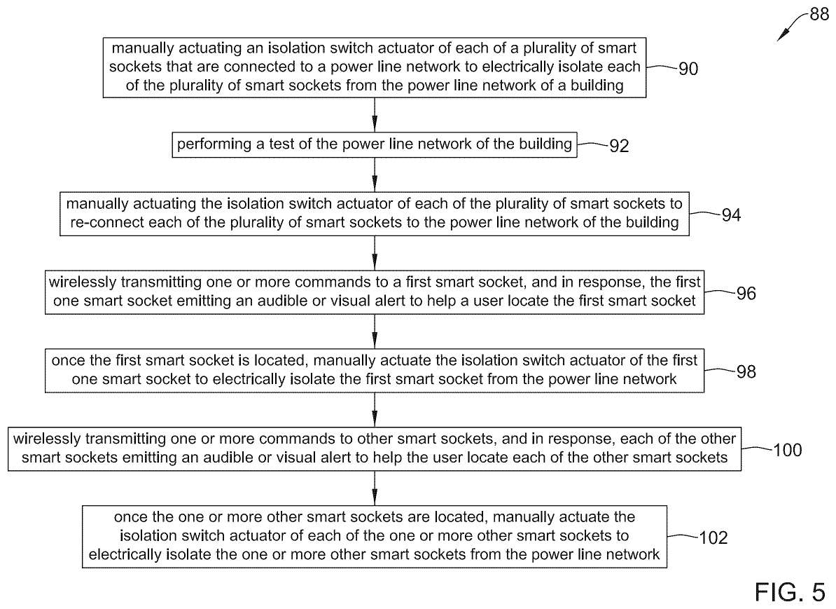

FIG. 5 is a flow diagram showing an illustrative method 88 for testing a power line network of a building, wherein the building includes a plurality of smart sockets (such as the smart socket 60) connected to the power line network. Each smart socket is configured to receive an electrical plug from a corresponding electrical appliance and each smart socket is configured to wirelessly report one or more power parameters of power delivered by the smart socket from the power line network to the corresponding electrical appliance. Each smart socket includes an isolation switch actuator (such as the isolation switch actuator 76) accessible from outside of the smart socket to actuate an isolation switch (such as the isolation switch 74) of the smart socket to electrically isolate the smart socket from the power line network of the building. The illustrative method 88 includes manually actuating the isolation switch actuator of each of the plurality of smart sockets that are connected to the power line network to electrically isolate each of the plurality of smart sockets from the power line network of the building, as indicated at block 90. A test of the power line network of the building is performed, as indicated at block 92. In some cases, the test includes an insulation integrity test for testing the insulation of one or more wires of the power line network, the insulation integrity test including applying a voltage and/or a current to one or more wires of the power line network that could damage one or more of a plurality of smart sockets if the isolation switches of the plurality of smart sockets were not actuated to electrically isolate each of the plurality of smart sockets from the power line network of the building.

The isolation switch actuator of each of the plurality of smart sockets is manually actuated to re-connect each of the plurality of smart sockets to the power line network of the building, as indicated at block 94. In some cases, the method 88 may further include wirelessly transmitting one or more commands to a first one of the plurality of smart sockets, and in response, the first one of the plurality of smart sockets emitting an audible or visual alert to help a user locate the first one of the plurality of smart sockets in the building, as indicated at block 96. Once the first one of the plurality of smart sockets is located, the isolation switch actuator of the first one of the plurality of smart sockets is manually actuated to electrically isolate the first one of the plurality of smart sockets from the power line network of the building, as indicated at block 98.

In some cases, the method 88 may further include wirelessly transmitting one or more commands to one or more other of the plurality of smart sockets, and in response, each of the one or more other of the plurality of smart sockets emitting an audible or visual alert to help the user locate the one or more other of the plurality of smart sockets in the building, as indicated at block 100. Once the one or more other of the plurality of smart sockets are located, the isolation switch actuator of each of the one or more other of the plurality of smart sockets is actuated to electrically isolate the one or more other of the plurality of smart sockets from the power line network of the building, as indicated at block 102.

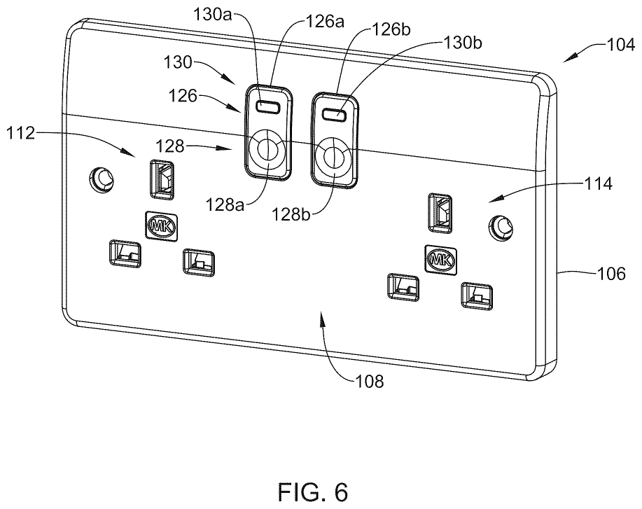

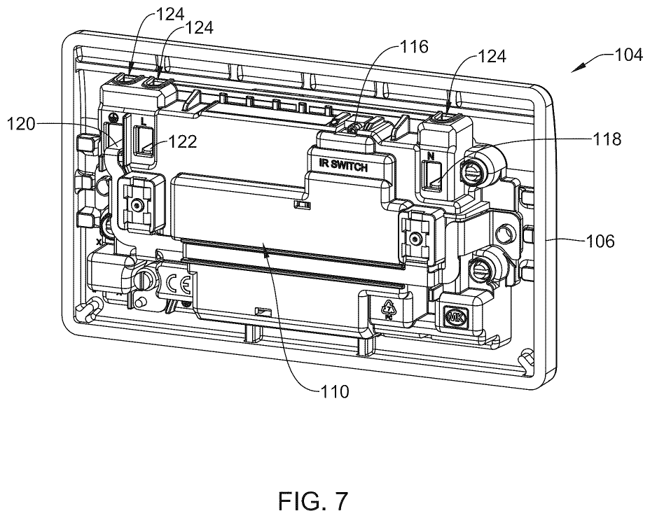

FIG. 6 is a front perspective view of an illustrative smart socket 104 and FIG. 7 is a back perspective view of the illustrative smart socket 104. The smart socket 104 may be considered as being an example of the smart socket 60. The smart socket 104 includes a housing 106 having a front side 108 and an opposing back side 110. As shown, the smart socket 104 includes a first socket receptacle 112 and a second socket receptacle 114, both of which are accessible from the front side 108 of the housing 106. As seen in FIG. 7, an isolation switch actuator 116 is accessible from the back side 110 of the housing 106. In some cases, since the isolation switch actuator 116 is located near an upper surface of the back side 110 of the housing 106, the isolation switch actuator 116 may be considered as also being accessible from the front side 108 of the housing 106. One or more power connections are also accessible from the back side 110 of the housing 106. As shown, the smart socket 104 includes a power connection 118, a power connection 120 and a power connection 122. Each of the power connections 118, 120 and 122 are wire terminals configured to accommodate a wire inserted therein, with a corresponding screw 124 that can be tightened down to secure the corresponding wire in place.

With reference to FIG. 6, the smart socket 104 includes a pair of receptacle switches 126, individually labeled as 126a and 126b. Each receptacle switch 126 includes a receptacle switch button 128, individually labeled as 128a and 128b. Each receptacle switch 126 includes a light 130, individually labeled as 130a and 130b.

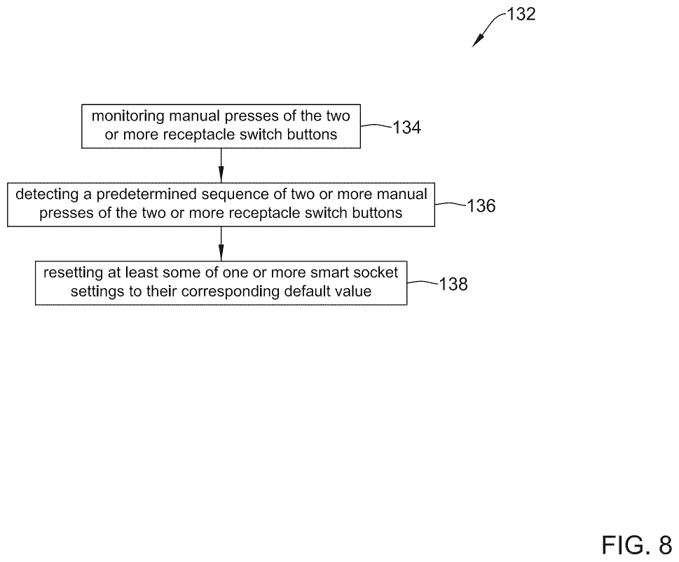

It will be appreciated that there are a number of different configuration settings that a user may wish to edit. In some cases, because there are a number of configuration settings that can be set (or incorrectly set), the user may wish to simply reset to a set of factory defaults using the method described in FIG. 8. Examples of BLE (Bluetooth Low Energy) Configuration settings include pan_id and key. Examples of Ethernet Configuration settings include Ethernet Mode, 0-dhcp, 1-static-IP, IP address, gateway address and IP mask. Examples of BACnet Configuration settings include Network number, Device instance, Port number, BBMD, BBMD TTL, and Hub replacement timeout value. Examples of Hub Configuration settings include Name, Reference and Location. Examples of Socket Configuration settings, which are included for every smart socket, include Mac, Name, IPV6 address, Shadow RAM Index and Location.

FIG. 8 is a flow diagram showing an illustrative method 132 for resetting one or more smart socket settings of a smart socket (such as the smart socket 104), wherein each of the smart socket settings can be changed from a default value to a programmed value. The smart socket includes two or more socket receptacles each for receiving an electrical plug, two or more power connections for connecting to a power source, a power input port for receiving input power from the one or more power connections and two or more receptacle switches each operatively coupled between the power input port and a corresponding socket receptacle. Each receptacle switch, when in a closed position, allows power to pass from the power input port to the corresponding socket receptacle, and when in an open position, does not allow power to pass from the power input port to the corresponding socket receptacle. The smart socket further includes two or more receptacle switch buttons, wherein each of the two or more receptacle switch buttons, when manually pressed by a user causes the corresponding receptible switch to alternately switch between the open position and the closed position (sometimes subject to an override by the controller 82). The method 132 includes monitoring manual presses of the two or more receptacle switch buttons, as indicated at block 134. The method 132 includes detecting a predetermined sequence of two or more manual presses of the two or more receptacle switch buttons, as indicated at block 136. In response to detecting a predetermined sequence of two or more manual presses of the two or more receptacle switch buttons, at least some of one or more smart socket settings are reset to their corresponding default value, as indicated at block 138.

In some cases, the predetermined sequence of two or more manual presses may include a manual press of a first one of the two or more receptacle switch buttons and a manual press of a second one of the two or more receptacle switch buttons. In some cases, the predetermined sequence of two or more manual presses may include a manual press of the first one of the two or more receptacle switch buttons followed by a manual press of the second one of the two or more receptacle switch buttons within a predetermined time window following the manual press of the first one of the two or more receptacle switch buttons. In some cases, the predetermined sequence of two or more manual presses may include a manual press and hold of the first one of the two or more receptacle switch buttons for at least a predetermined press and hold time period, followed by a manual press of the second one of the two or more receptacle switch buttons within a predetermined time window following the manual press and hold of the first one of the two or more receptacle switch buttons.

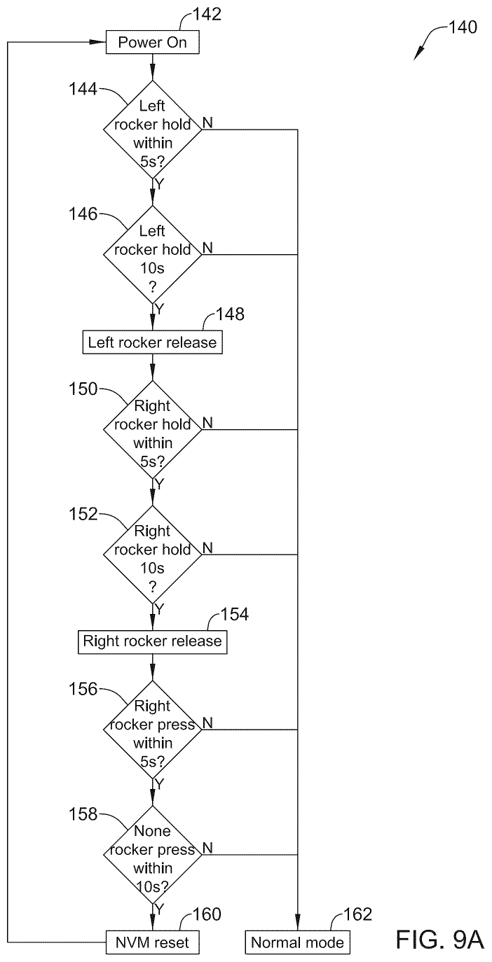

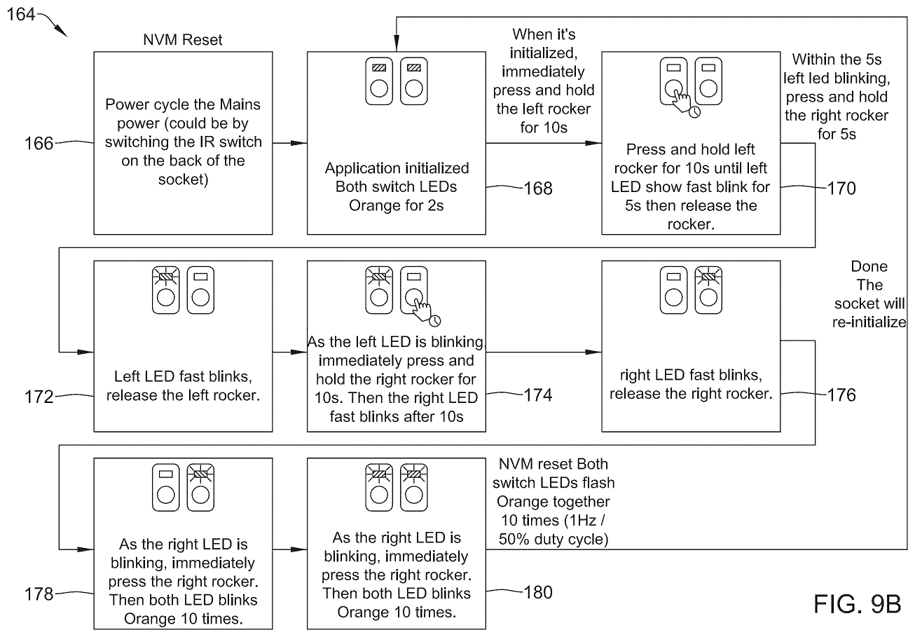

FIG. 9A is a flow diagram showing an illustrative method 140 for resetting a smart socket that includes a left rocker and a right rocker. The left rocker and the right rocker represent receptacle switch buttons. The power is turned on, as indicated at block 142. At decision block 144, a determination is made as to whether the left rocker was held within five seconds. If so, control passes to a decision block 146, where a determination is made as to whether the left rocker was held down for at least ten seconds. If so, control passes to block 148 and the left rocker is released. Control passes to decision block 150, where a determination is made as to whether the right rocker was held within five seconds. If so, control passes to decision block 152, where a determination is made as to whether the right rocker was held down for at least ten seconds. If so, control passes to block 154 and the right rocker is released. Control passes to decision block 156, where a determination is made as to whether the right rocker is pressed again within five seconds. Control passes to decision block 158, where a determination is made as to whether any rockers were pressed within 10 seconds. If no rockers were pressed, control passes to block 160 and a reset is performed. If at any of the decision blocks 144, 146, 150, 152, 156 and 158 the answer was no, control would jump to block 162, which is a normal mode.

FIG. 9B is a flow diagram showing an illustrative method 164 for resetting a smart socket that includes a pair of receptacle switches. The power is turned on, as indicated at block 166. The application is initialized and the lights blink orange, as indicated at block 168. At block 170, the left switch is held for ten seconds until its light blinks for five seconds, and is then released. At block 172, the left light fast blinks red, and the left switch is released. At block 174, the right switch is pressed and held for ten seconds. At block 176, the right light fast blinks red, and the switch is released. At block 178, the right switch is pressed while the right light is blinking. At block 180, both lights blink orange for ten seconds and a reset is performed.

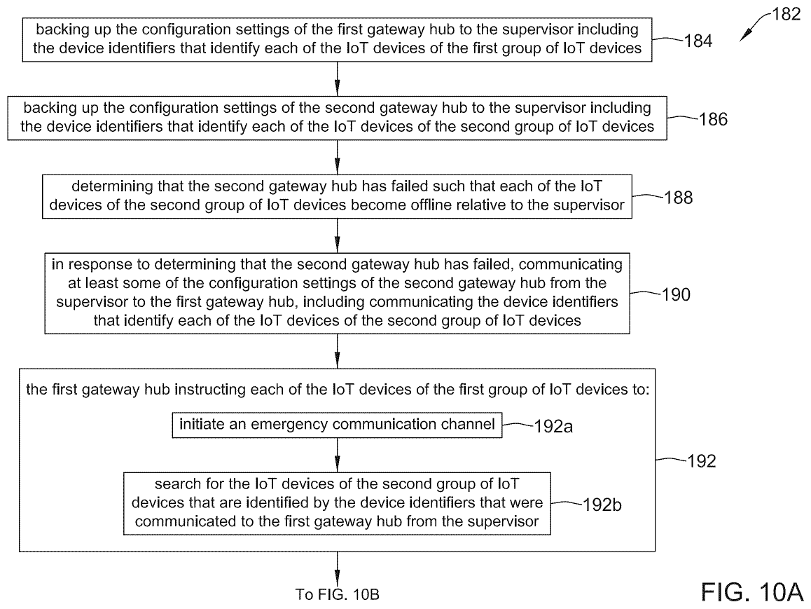

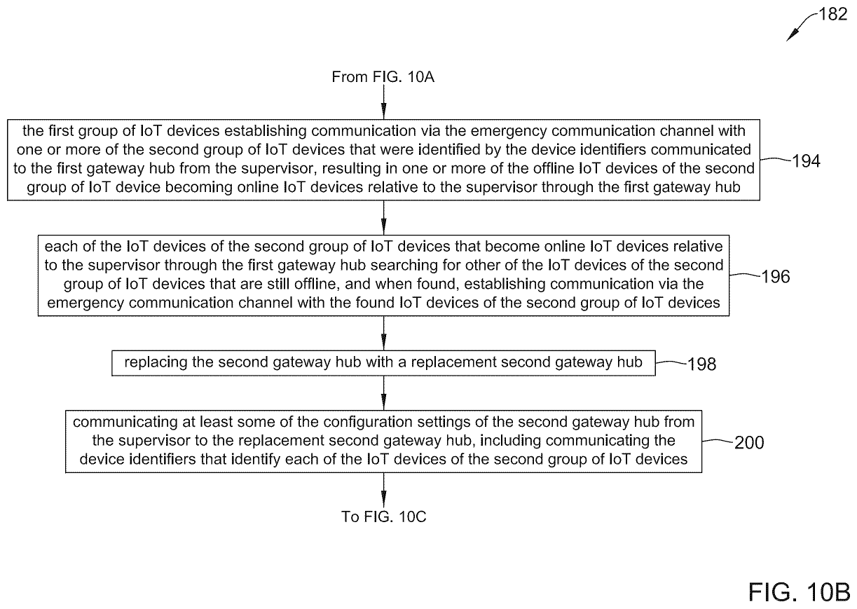

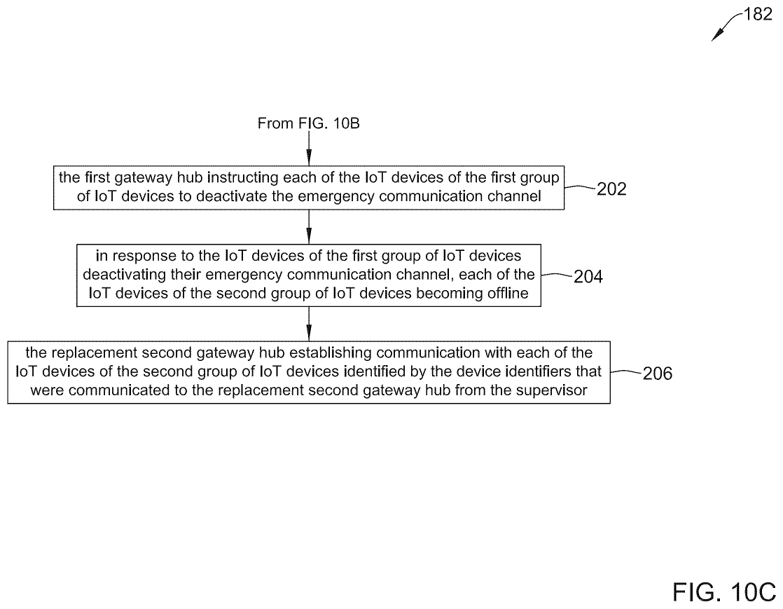

FIGS. 10A, 10B and 10C are flow diagrams that together show an illustrative method 182 for maintaining communication between a supervisor and a plurality of IoT devices, wherein a first group of the plurality of IoT devices are configured in a first wireless mesh network that includes a first gateway hub, and a second group of plurality of IoT devices are configured in a second wireless mesh network that includes a second gateway hub. The first gateway hub and the second gateway hub are in communication with the supervisor and provide communication between the first group of IoT devices and the supervisor and between the second group of IoT devices and the supervisor, respectively. The first gateway hub storing a plurality of configuration settings including device identifiers that identify each of the IoT devices of the first group of IoT devices that are part of the first wireless mesh network, and the second gateway hub storing a plurality of configuration settings including device identifiers that identify each of the IoT devices of the second group of IoT devices that are part of the second wireless mesh network. In some cases, at least some of the IoT devices are smart sockets.

The method 182 includes backing up the configuration settings of the first gateway hub to the supervisor including the device identifiers that identify each of the IoT devices of the first group of IoT devices, as indicated at block 184. The configuration settings of the second gateway hub are backed up to the supervisor including the device identifiers that identify each of the IoT devices of the second group of IoT devices, as indicated at block 186. In some cases, the configuration settings of the first gateway hub and the configuration settings of the second gateway hub are backed up to the supervisor periodically, such as once per hour, once per day, once per week, etc. In some cases, the configuration settings of the first gateway hub and the configuration settings of the second gateway hub are backed up when the configuration settings change. These are just examples.

A determination is made that the second gateway hub has failed such that each of the IoT devices of the second group of IoT devices become offline relative to the supervisor, as indicated at block 188. In response to determining that the second gateway hub has failed, at least some of the configuration settings of the second gateway hub are communicated from the supervisor to the first gateway hub, including communicating the device identifiers that identify each of the IoT devices of the second group of IoT devices, as indicated at block 190.

The method 182 includes the first gateway hub instructing each of the IoT devices of the first group of IoT devices to carry out several steps, as indicated at block 192. These steps include initiating an emergency communication channel, as indicated at block 192a. These steps include searching for the IoT devices of the second group of IoT devices that are identified by the device identifiers that were communicated to the first gateway hub from the supervisor, as indicated at block 192b.

The method 182 continues on FIG. 10B, with the first group of IoT devices establishing communication via the emergency communication channel with one or more of the second group of IoT devices that were identified by the device identifiers communicated to the first gateway hub from the supervisor, resulting in one or more of the offline IoT devices of the second group of IoT device becoming online IoT devices relative to the supervisor through the first gateway hub, as indicated at block 194. In some cases, the method 182 may further include each of the IoT devices of the second group of IoT devices that become online IoT devices relative to the supervisor through the first gateway hub searching for other of the IoT devices of the second group of IoT devices that are still offline, and when found, establishing communication via the emergency communication channel (or the mesh network) with the found IoT devices of the second group of IoT devices, as indicated at block 196. In some cases, the method 182 further includes replacing the second gateway hub with a replacement second gateway hub, as indicated at block 198. At least some of the configuration settings of the second gateway hub are communicated from the supervisor to the replacement second gateway hub, including communicating the device identifiers that identify each of the IoT devices of the second group of IoT devices, as indicated at block 200.

The method 182 continues on FIG. 10C, with the first gateway hub instructing each of the IoT devices of the first group of IoT devices to deactivate the emergency communication channel, as indicated at block 202. In response to the IoT devices of the first group of IoT devices deactivating their emergency communication channel, each of the IoT devices of the second group of IoT devices become offline, as indicated at block 204. The replacement second gateway hub establishes communication with each of the IoT devices of the second group of IoT devices identified by the device identifiers that were communicated to the replacement second gateway hub from the supervisor, as indicated at block 206.

In some cases, the first wireless mesh network may operate in accordance with a first communication protocol, and the emergency communication channel may operate in accordance with a second communication protocol, where the second communication protocol is different from the first communication protocol. In some cases, the first wireless mesh network may operate in accordance with a frequency hopping protocol and the emergency communication channel may operate in accordance with a fixed frequency communication channel. These are just examples.

In some cases, the first gateway hub and the second gateway hub are in wired communication with the supervisor. In some cases, the first gateway hub and the second gateway hub communicate with the supervisor over a BACNET network. In some cases, the supervisor may include a server. Backing up the configuration settings of the first gateway hub to the supervisor may be automatically repeated on a regular basis. Backing up the configuration settings of the first gateway hub to the supervisor may be automatically repeated every 24 hours or less. Examples of configuration settings of the first gateway hub include communication parameters, gateway hub configuration parameters, and IoT parameters including a device identifier for each of the IoT devices of the first group of IoT devices.

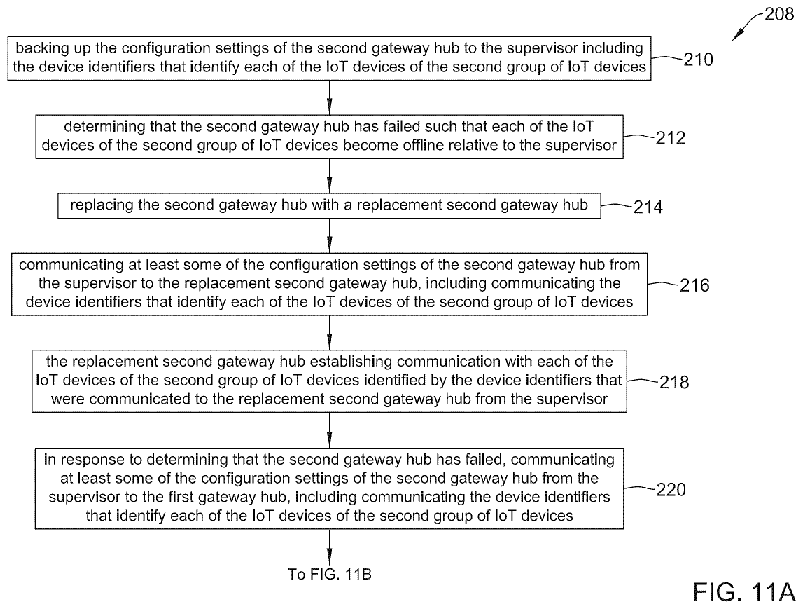

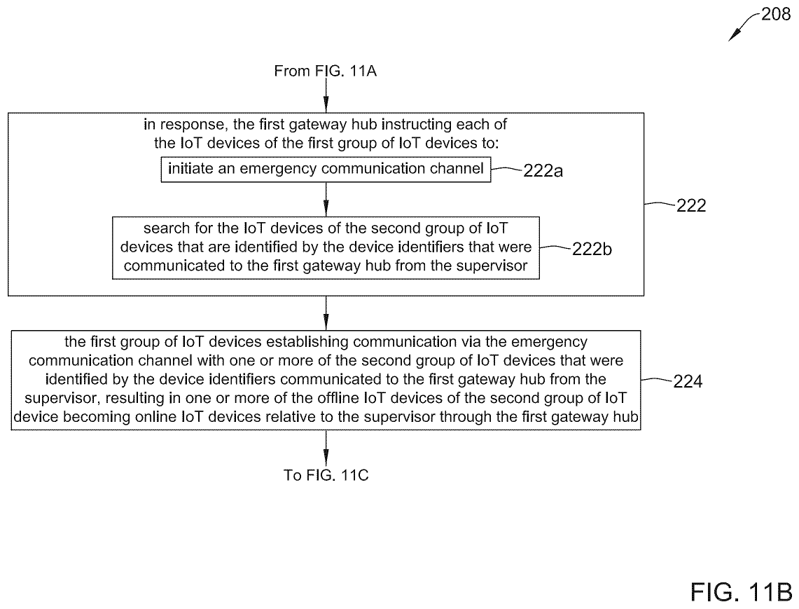

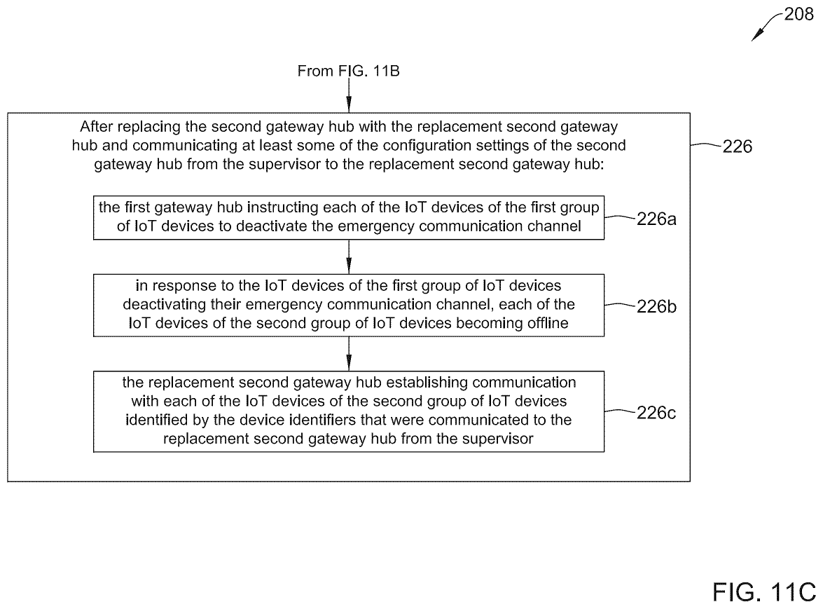

FIGS. 11A, 11B and 11C are flow diagrams that together show an illustrative method 208 for maintaining communication between a supervisor and a plurality of IoT devices, wherein a first group of the plurality of IoT devices are configured in a first wireless mesh network that includes a first gateway hub, and a second group of plurality of IoT devices are configured in a second wireless mesh network that includes a second gateway hub. The first gateway hub and the second gateway hub are in communication with the supervisor and provide communication between the first group of IoT devices and the supervisor and between the second group of IoT devices and the supervisor, respectively. The first gateway hub storing a plurality of configuration settings including device identifiers that identify each of the IoT devices of the first group of IoT devices that are part of the first wireless mesh network, and the second gateway hub storing a plurality of configuration settings including device identifiers that identify each of the IoT devices of the second group of IoT devices that are part of the second wireless mesh network.

The method 208 includes backing up the configuration settings of the second gateway hub to the supervisor including the device identifiers that identify each of the IoT devices of the second group of IoT devices, as indicated at block 210. The method 208 includes determining that the second gateway hub has failed such that each of the IoT devices of the second group of IoT devices become offline relative to the supervisor, as indicated at block 212. The second gateway hub is replaced with a replacement second gateway hub, as indicated at block 214. At least some of the configuration settings of the second gateway hub are communicated from the supervisor to the replacement second gateway hub, including communicating the device identifiers that identify each of the IoT devices of the second group of IoT devices, as indicated at block 216. The replacement second gateway hub establishes communication with each of the IoT devices of the second group of IoT devices identified by the device identifiers that were communicated to the replacement second gateway hub from the supervisor, as indicated at block 218.

In response to determining that the second gateway hub has failed, at least some of the configuration settings of the second gateway hub are communicated from the supervisor to the first gateway hub, including communicating the device identifiers that identify each of the IoT devices of the second group of IoT devices, as indicated at block 220. The method 208 continues on FIG. 11B, where in response, the first gateway hub instructs each of the IoT devices of the first group of IoT devices to take several steps, as indicated at block 222. These steps include initiating an emergency communication channel, as indicated at block 222a. These steps include searching for the IoT devices of the second group of IoT devices that are identified by the device identifiers that were communicated to the first gateway hub from the supervisor, as indicated at block 222b. The first group of IoT devices establishes communication via the emergency communication channel with one or more of the second group of IoT devices that were identified by the device identifiers communicated to the first gateway hub from the supervisor, resulting in one or more of the offline IoT devices of the second group of IoT device becoming online IoT devices relative to the supervisor through the first gateway hub, as indicated at block 224.

The method 208 continues on FIG. 11C, where after replacing the second gateway hub with the replacement second gateway hub and communicating at least some of the configuration settings of the second gateway hub from the supervisor to the replacement second gateway hub, several steps take place, as indicated at block 226. These steps include the first gateway hub instructing each of the IoT devices of the first group of IoT devices to deactivate the emergency communication channel, as indicated at block 226a. These steps include in response to the IoT devices of the first group of IoT devices deactivating their emergency communication channel, each of the IoT devices of the second group of IoT devices becoming offline, as indicated at block 226b. These steps include the replacement second gateway hub establishing communication with each of the IoT devices of the second group of IoT devices identified by the device identifiers that were communicated to the replacement second gateway hub from the supervisor, as indicated at block 226c.

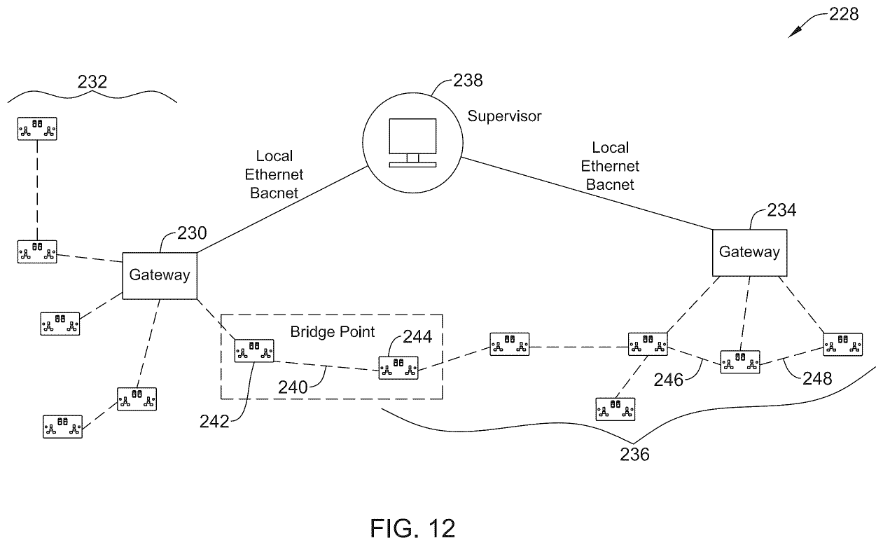

FIG. 12 is a schematic view of an illustrative emergency communication scenario within a mesh network 228. A first gateway 230 is in communication with a first group 232 of smart sockets via a first mesh network. A second gateway 234 was, until failure, in communication with a second group 236 of smart sockets via a second mesh network. The first gateway 230 connects with a supervisor 238 with a wired connection having a Bacnet communication protocol. Until failure, the second gateway 234 connected with the supervisor 238 with a wired connection having a Bacnet communication protocol. Now that the second gateway 234 has failed, the second group 236 of smart sockets are unable to communicate with the supervisor 238. An emergency communication routine is triggered, in which the supervisor 238 informs the first gateway 230 of the identity of all of the smart sockets that normally communicate with the second gateway 234. This allows the second gateway 234, and the first group 232 of smart sockets associated with the second gateway 234, to search for the second group 236 of smart sockets using an emergency communication channel.

As a result, a bridge 240 forms between a smart socket 242 within the first group 232 of smart sockets and a smart socket 244 within the second group 236 of smart sockets via the emergency channel. As a result, the smart socket 244 is able to communicate with the first gateway 230 and hence with the supervisor 238. Additional bridges 246 and 248 allow other smart sockets within the second group 236 of smart sockets to communicate with other of the second group 236 of smart sockets via the emergency channel without support from the second gateway 234, and ultimately establish a communication pathway (via the emergency channel and/or mesh networks) to the first gateway 230 and hence the supervisor 238 until such time as the second gateway 234 is replaced.

In some cases, the first and second wireless mesh networks may operate in accordance with a first communication protocol, and the emergency communication channel may operate in accordance with a second communication protocol, where the second communication protocol is different from the first communication protocol. In some cases, the first wireless mesh network may operate in accordance with a frequency hopping protocol and the emergency communication channel may operate in accordance with a fixed frequency communication channel. These are just examples.

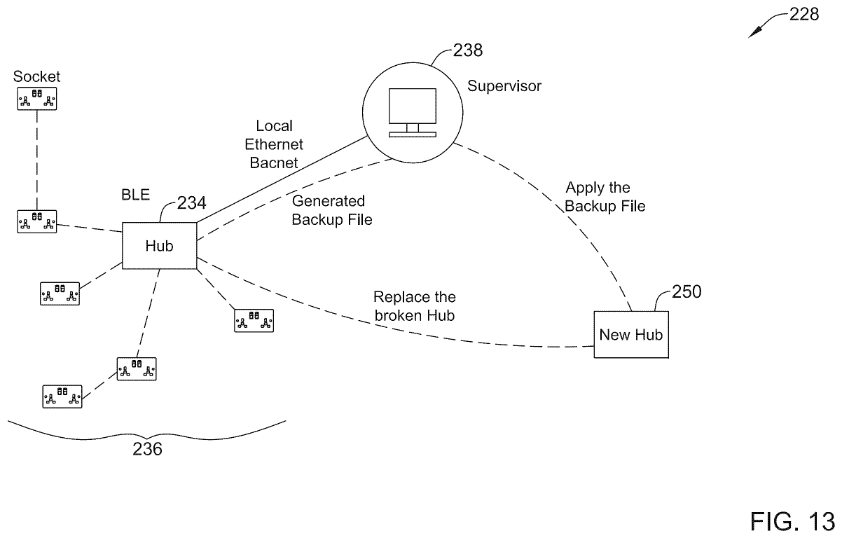

FIG. 13 shows a portion of the mesh network 228 including the broken second gateway 234. The broken second gateway 234 is disconnected and is replaced with a new gateway 250. The new gateway 250 will have the same IP address as the broken second gateway 234 it is replacing. Once installed, the supervisor 238 will download a backup file previously backed up from the second gateway to the new gateway 250. This allows the new gateway 250 to function identically to how the second gateway 234 functioned prior to failure.

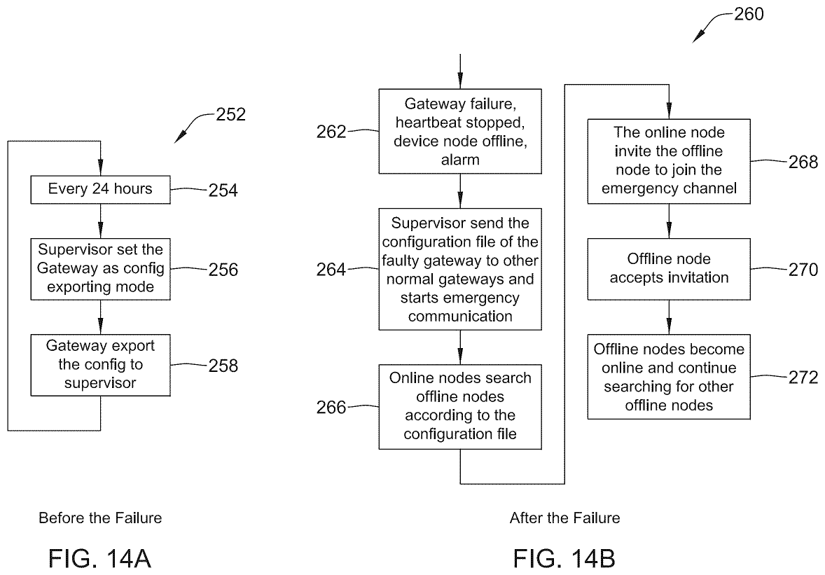

FIG. 14A is a flow diagram showing an illustrative method 252 that takes place prior to failure of the second gateway 234. The method 252 takes place every 24 hours, as indicated at block 254. The supervisor instructs the gateway to export its configuration, as indicated at block 256. In response, the gateway exports its configuration to the supervisor, as indicated at block 258. This export becomes a backup file that will be downloaded to a replacement gateway should the gateway fail.

FIG. 14B is a flow diagram showing an illustrative method 260. In this example, a loss of heartbeat signal indicates a gateway failure, as indicated at block 262. The supervisor sends the backup info for the failed gateway to other gateways and starts emergency communication, as indicated at block 264. Online mesh nodes search for offline nodes, as indicated at block 266. Online nodes invite the offline nodes, once found, to join the emergency communication channel, as indicated at block 268. The offline node accepts the invitation, as indicated at block 270. The offline node becomes online nodes and continues searching for other offline nodes, as indicated at block 272.

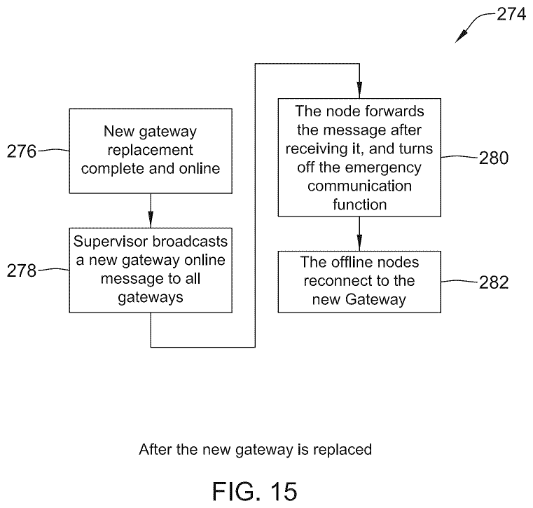

FIG. 15 is a flow diagram showing an illustrative method 274. A new gateway has been installed and is online, as indicated at block 276. The supervisor broadcasts a new gateway online message to all gateways, as indicated at block 278. The node forwards the message after receipt and turns off the emergency communication channel, as indicate at block 280. The offline nodes connect to the new gateway, as indicated at block 282.

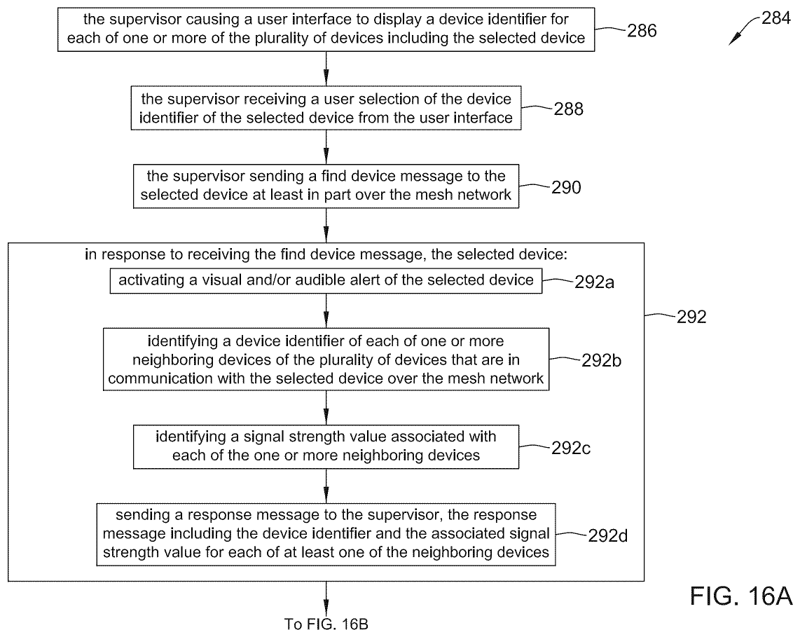

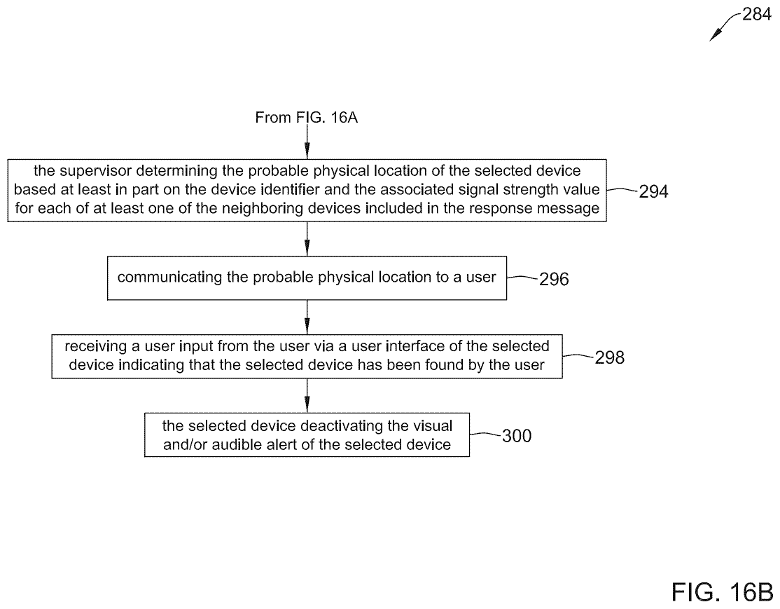

FIGS. 16A and 16B are flow diagrams that together show an illustrative method 284 for identifying a probable physical location of a selected device of a plurality of devices operatively coupled in a mesh network, wherein each of the plurality of devices is in communication with a supervisor. The method 284 includes the supervisor causing a user interface to display a device identifier for each of one or more of the plurality of devices including the selected device, as indicated at block 286. The supervisor receives a user selection of the device identifier of the selected device from the user interface, as indicated at block 288. The supervisor sends a find device message to the selected device at least in part over the mesh network, as indicated at block 290.

In response to receiving the find device message, the selected device implements several steps, as indicated at block 292. These steps include activating a visual and/or audible alert of the selected device, as indicated at block 292a. These steps include identifying a device identifier of each of one or more neighboring devices of the plurality of devices that are in communication with the selected device over the mesh network, as indicated at block 292b. These steps include identifying a signal strength value associated with each of the one or more neighboring devices, as indicated at block 292c. These steps include sending a response message to the supervisor, the response message including the device identifier and the associated signal strength value for each of at least one of the neighboring devices, as indicated at block 292d.

The method 284 continues on FIG. 16B, with the supervisor determining the probable physical location of the selected device based at least in part on the device identifier and the associated signal strength value for each of at least one of the neighboring devices included in the response message, as indicated at block 294. The probable physical location is communicated to a user, as indicated at block 296. In some cases, the method 284 continues with receiving a user input from the user via a user interface of the selected device indicating that the selected device has been found by the user, as indicated at block 298. In response, the selected device deactivates the visual and/or audible alert of the selected device, as indicated at block 300.

In some cases, the probable physical location of the selected device may be communicated as being adjacent to a physical location of an identified one of the neighboring devices. The identified one of the neighboring devices may be the neighboring device that has the highest signal strength value identified by the selected device, for example. In some cases, determining the probable physical location of the selected device may include triangulating from known locations of three or more of the neighboring devices using their respective signal strength values.

The known location of one or more of the neighboring devices may be used to determine the probable physical location of the selected device. In some cases, the probable physical location of the selected device may be expressed as being in proximity to a particular one of the neighboring devices (e.g. near neighboring Device X), as being in a particular room of a building (e.g. in the lunch room) particularly when the physical location of at least some of the neighboring devices are known), as being in a particular region expressed using a coordinate system such as GPS), and/or expressed in any other suitable manner.

In some cases, the response message may be sent to the supervisor through one or more routing devices of the plurality of devices of the mesh network, wherein each of the one or more routing devices adds its device identifier to the response message. In some cases, the supervisor may determine the probable physical location of the selected device based at least in part on the device identifier and the associated signal strength value for each of at least one of the neighboring devices included in the response message, and at least one of the device identifiers of the one or more routing devices added to the response message. The supervisor may be a server. The user interface may be displayed on a display that is operatively coupled to the server via a wired network connection. The user interface may be displayed on a display of a tablet computer or a smart phone that is operatively coupled to the server at least in part via a wireless network connection.

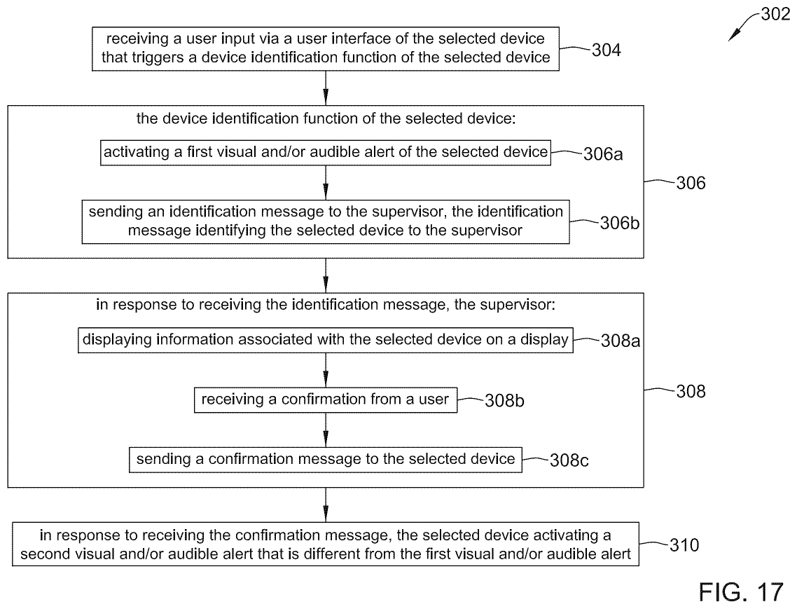

FIG. 17 is a flow diagram showing an illustrative method 302 for confirming connectivity of a selected device of a plurality of devices that are operatively coupled in a mesh network, wherein each of the plurality of devices is in communication with a supervisor. The method includes receiving a user input via a user interface of the selected device that triggers a device identification function of the selected device, as indicated at block 304. The device identification function of the selected device carries out several steps, as indicated at block 306. The steps include activating a first visual and/or audible alert of the selected device, as indicated at block 306a. The steps include sending an identification message to the supervisor, the identification message identifying the selected device to the supervisor, as indicated at block 306b. In response to receiving the identification message, the supervisor carries out several steps, as indicated at block 308. The steps include displaying information associated with the selected device on a display, as indicated at block 308a. The steps include receiving a confirmation from a user, as indicated at block 308b. The steps include sending a confirmation message to the selected device, as indicated at block 308c. In response to receiving the confirmation message, the selected device activates a second visual and/or audible alert that is different from the first visual and/or audible alert, as indicated at block 310.

In some cases, each of the plurality of devices may be in communication with a gateway hub via the mesh network, and the gateway hub may be in communication with the supervisor via a wired network connection. In some cases, after the selected device activates the second visual and/or audible alert, the selected device terminates the second visual and/or audible alert after a timeout period.

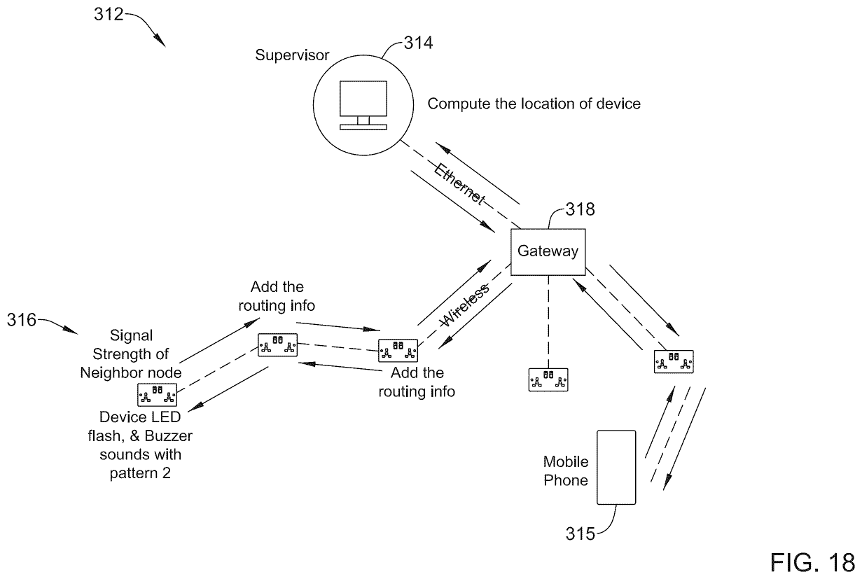

FIG. 18 is a schematic view of an illustrative scenario of looking for a device within a mesh network 312. To start, a user may press the find button of a supervisor 314 (or an application running on a mobile phone 315). The find message is sent to the device, such as one of several smart sockets 316. In some cases, the find message passes through a gateway 318 before reaching one of the smart sockets 316. The device receiving the find message responds with a signal strength of each of its neighboring nodes. The forwarding node adds its ID to the find message. The supervisor 314 computes a probable location of the device. The user will then travel to the probably location and try to find the device with the aid of the device's flashing light and/or audible buzzer.

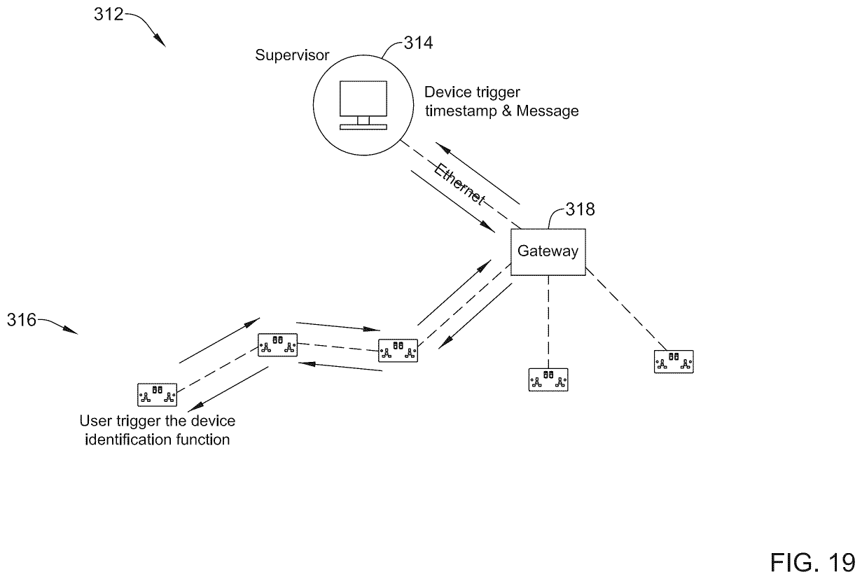

FIG. 19 is a schematic view of an illustrative scenario of confirming the functioning of a device within the mesh network 312. A user may trigger a device identification function of the device, causing the device to flash a first LED light pattern. In response, the supervisor 314 (or mobile phone 315) displays the information of the triggered device. The user can press a confirm button on the supervisor 314 or the mobile phone 315, and the device will flash a second LED light pattern and the buzzer will sound. After a timeout period, the devices stop flashing and buzzing.

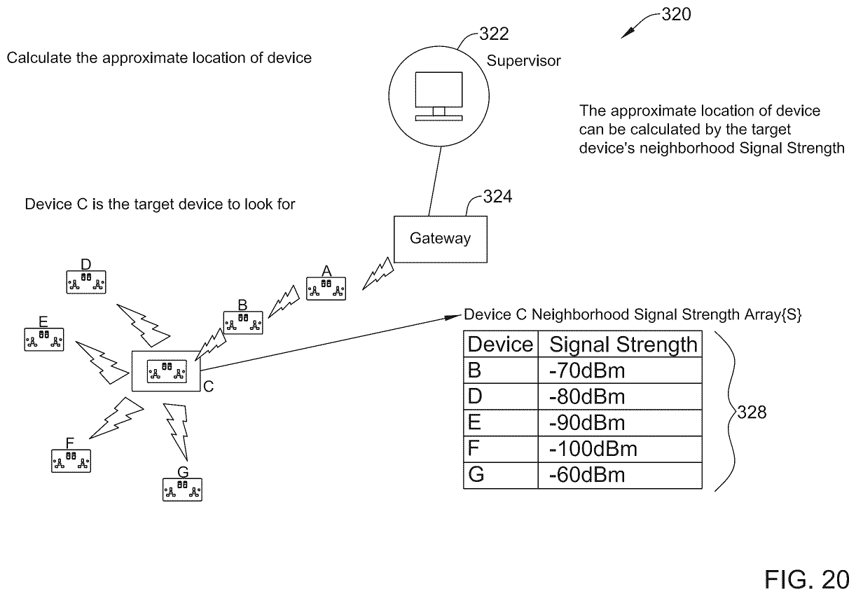

FIG. 20 is a schematic view of an illustrative scenario of ascertaining a probable location of a device within a mesh network 320. The mesh network 320 includes a supervisor 322, a gateway 324 and a target smart socket 326. An approximate location of the target smart socket 326 may be ascertained by determining a signal strength between the target smart socket 326 and each of its neighbors, labeled B, D, E, F, G and H. The relative signal strengths are summarized in a table 328.

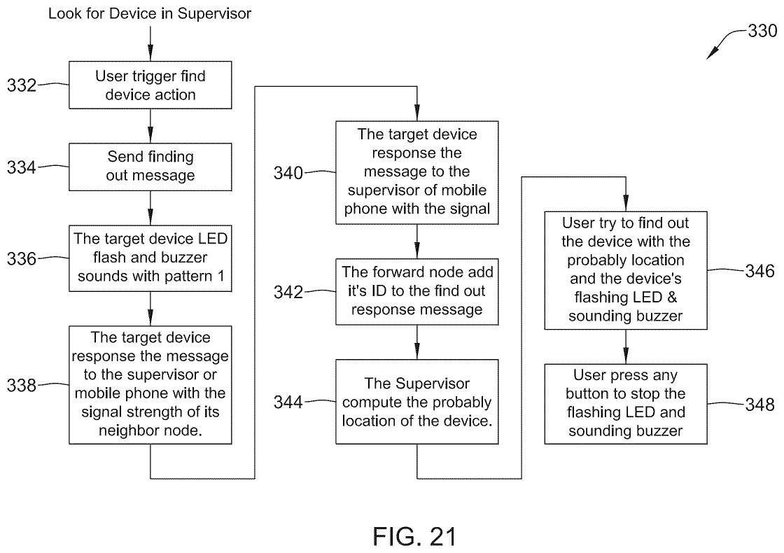

FIG. 21 is a flow diagram showing an illustrative method 330 for looking for a device. The method 330 includes a user triggering a find device action, as indicated at block 332. A finding out message is sent, as indicated at block 334. The target device flashes its LED and sounds its buzzer with a first pattern, as indicated at block 336. The target device reports back to the supervisor with signal strength of its neighboring node, as indicated at blocks 338 and 340. A forward node, if any, adds its ID to the find out response message, as indicated at block 342. The supervisor determines the probable location of the target device, as indicated at block 344. The user tries to find the device, as indicated at block 346. Once found, the user presses any button on the target device to stop the flashing LED and sounding buzzer, as indicated at block 348.

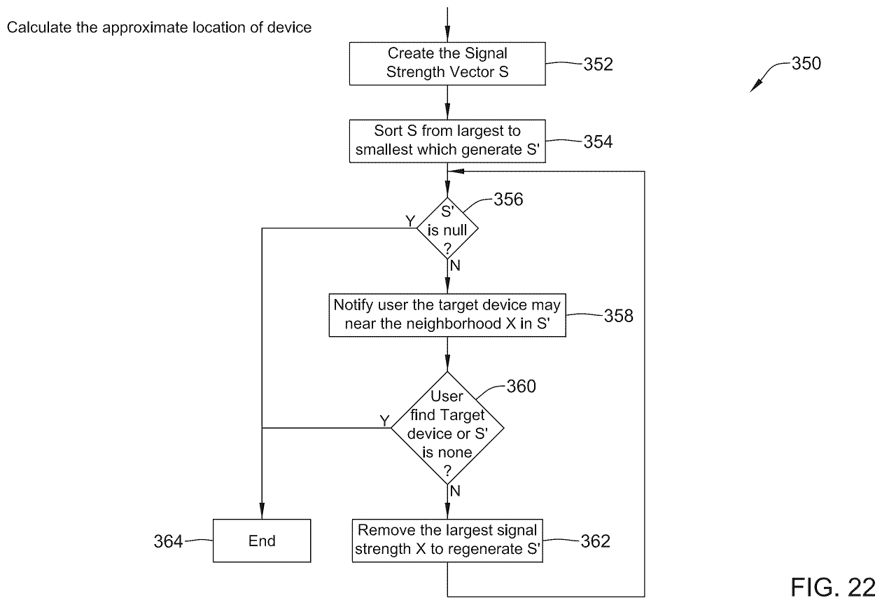

FIG. 22 is a flow diagram showing an illustrative method 350 for determining the approximate location of a target device without having access to any building information model information. A signal strength vector is created, as indicated at block 352. The signal strength vector is sorted from largest to smallest, as indicated at block 354. At a decision block 356, a determination is made as to whether the sorted signal strength vector is a null vector. If not, meaning that the vector includes one or more signal strength values, control passes to block 358 and the user is notified that the target device may be near a particular device. At a decision block 360, a determination is made as to whether the user found the target device. If not, the largest remaining signal strength is removed from the sorted signal strength vector, as indicated at block 362, and control then reverts to decision block 356. However, if the sorted signal strength vector is null, as indicated at decision block 356, or if the user found the target device at decision block 360, control passes to end block 364.

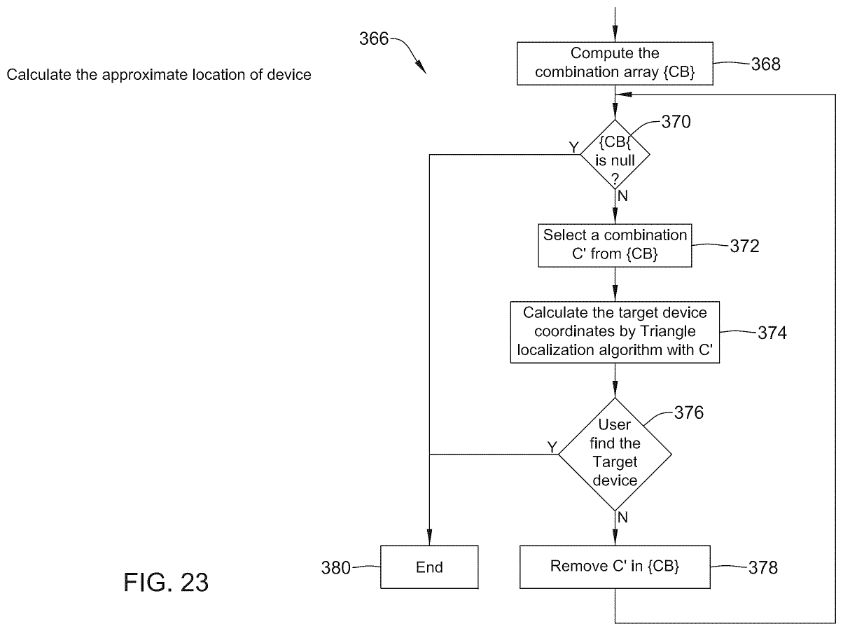

FIG. 23 is a flow diagram showing an illustrative method 368 for determining the approximate location of a target device with access to building information model information. The model 368 begins with computing a combination array, as indicated at block 370. At a decision block 372, a determination is made as to whether the combination array is null. If not, control passes to block 372 and a new combination is selected from the combination array. Target device coordinates are calculated, as indicated at block 374. The target device coordinates may be calculated using triangulation from known locations of three or more of the neighboring devices using their respective signal strength values. At a decision block 376, a determination is made as to whether the user found the target device. If not, control passes to block 378, and the just used combination is removed from the combination array. However, if the combination array is null, as indicated at decision block 370, or if the user finds the target device as indicated at decision block 376, control passes to end block 378.

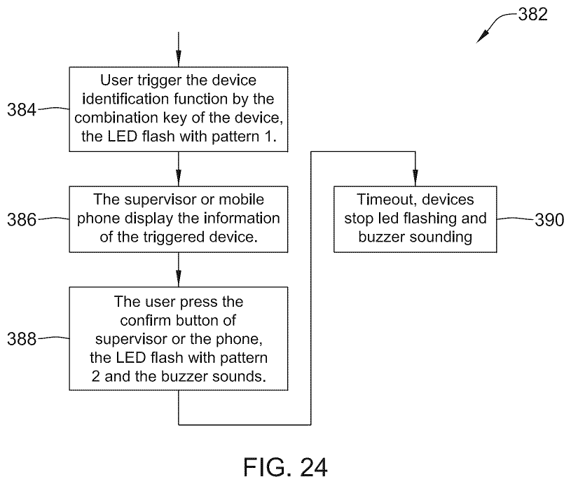

FIG. 24 is a flow diagram showing an illustrative method 382 for identifying a device. The method 382 begins with the user triggering the device identification function of a target device, causing the LED of the target device to flash with pattern one, as indicated at block 384. The supervisor or mobile phone displays the information of the triggered device, as indicated at block 386. The user presses a confirm button of the supervisor or mobile phone, causing the LED to flash with pattern two and the buzzer to sound of the target device, as indicated at block 388. After timeout, the target devices stops flashing and buzzing, as indicated at block 390.

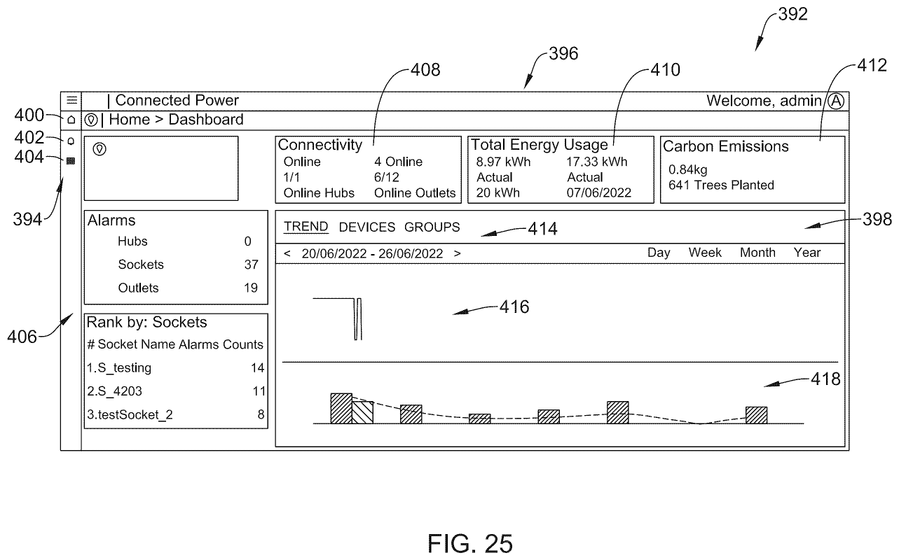

FIG. 25 is a screen shot showing an illustrative dashboard 392 that may be displayed for a system such as system 10 of FIG. 1 with a plurality of smart sockets. The dashboard 392 provides a summary of information derived from the plurality of smart sockets. The smart sockets may capture information related to the smart sockets, such as power consumption, connectivity and various alarms. This information may be displayed on a dashboard such as the dashboard 392. The dashboard 392 may display information for an entire building, a portion of a building, or even a summary of multiple buildings. As shown, the dashboard 392 may be considered as being divided into several area. The dashboard 392 includes a navigation pane 394, a title bar 396 and an information pane 398. The navigation pane 394 includes a HOME icon 400, an ALARM icon 402 and a SCHEDULE icon 404. These icons may be used to navigate between a HOME screen (as shown), an ALARM screen or a SCHEDULE screen. The title bar 396 includes information such as a station name and a user type (Admin or Non-Admin).

The information pane 398 may be considered as being divided into a number of sections. Along the left side of the information pane 398 is an alarm widget 406 indicating how many hubs, sockets and outlets (e.g. receptacles) are currently in alarm. The alarm widget 406 may include a ranked listing of which sockets have the greatest number of alarms. Across the top of the information pane 398 is a connectivity widget 408 showing a number of online devices and a number of offline devices. An energy usage widget 410 provides details on current and historical energy consumption. A carbon emissions section 412 provides information detailing how the reduced carbon emissions result from reduced energy consumption.

The information pane 398 includes a tool bar 414 that allows a user to select between TREND (as shown), DEVICES and GROUPS. Depending on the selection made via the tool bar 414, the information pane 398 includes a first graph 416 showing system power usage and a second graph 418 showing an energy comparison. Other graphs may also be displayed in this section.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A smart socket comprising:
a housing that houses:
one or more socket receptacles each for receiving an electrical plug;
one or more power connections for connecting to a power source;
a power input port for receiving input power from the one or more power connections;
one or more receptacle switches each operatively coupled between the power input port and a corresponding socket receptacle, each receptacle switch, when in a closed position, allows power to pass from the power input port to the corresponding socket receptacle, and when in an open position, does not allow power to pass from the power input port to the corresponding socket receptacle;
one or more receptacle switch buttons accessible from outside of the housing, wherein each of the one or more receptacle switch buttons, when manually pressed by a user causes the corresponding receptible switch to alternately switch between the open position and the closed position;
a meter for capturing one or more electrical characteristics of power that is delivered to each of the one or more socket receptacles;
a wireless communication circuit for wirelessly communicating with a remote device;
a controller operatively coupled to the one or more receptacle switches, the meter and the wireless communication circuit, the controller configured to:
receive from the meter one or more of the captured electrical characteristics of the power that is delivered to each of the one or more socket receptacles;
transmit via the wireless communication circuit one or more power parameters that are based at least in part on one or more of the received electrical characteristics of the power that is delivered to the one or more socket receptacles;
receive one or more commands via the wireless communication circuit, including a command that causes the controller to switch one or more of the receptacle switches between the closed position and the open position;
the controller further includes a non-volatile memory for storing one or more smart socket settings that each can be changed from a default value to a programmed value, wherein the controller references the one or more smart socket settings to control one or more operations of the smart socket; and
the controller configured to monitor manual presses of the one or more receptacle switch buttons, and in response to detecting a predetermined sequence of two or more manual presses of the one or more receptacle switch buttons, resets at least some of the one or more smart socket settings to their corresponding default values.

2. The smart socket of claim 1 further comprising:
one or more lights visible from outside of the housing, each of the one or more lights is associated with a corresponding one of the one or more receptacle switch buttons, and wherein the controller is configured to control the illumination of each of the one or more lights.

3. The smart socket of claim 2, wherein the controller controls the illumination of each of the one or more lights in a manner that confirms each of the manual presses of the predetermined sequence of two or more manual presses.

4. The smart socket of claim 1, wherein detecting the predetermined sequence of two or more manual presses of the one or more receptacle switch buttons comprises detecting a manual press and hold of one of the receptacle switch buttons for at least a predetermined press and hold time period.

5. The smart socket of claim 1, wherein detecting the predetermined sequence of two or more manual presses of the one or more receptacle switch buttons comprises detecting a manual press occurring within a predetermined time window from a triggering event.

6. The smart socket of claim 5, wherein the triggering event comprises a manual press and release of one of the receptacle switch buttons.

7. The smart socket of claim 5, wherein the triggering event comprises providing input power to the power input port after a time of not providing input power to the power input port.

8. The smart socket of claim 1, wherein the smart socket comprises two or more socket receptacles, two or more receptacle switches, and two or more receptacle switch buttons, wherein the predetermined sequence of two or more manual presses comprises a manual press of a first one of the two or more receptacle switch buttons and a manual press of a second one of the two or more receptacle switch buttons.

9. The smart socket of claim 8, wherein the predetermined sequence of two or more manual presses comprises a manual press of the first one of the two or more receptacle switch buttons followed by a manual press of the second one of the two or more receptacle switch buttons within a predetermined time window following the manual press of the first one of the two or more receptacle switch buttons.

10. The smart socket of claim 8, wherein the predetermined sequence of two or more manual presses comprises a manual press and hold of the first one of the two or more receptacle switch buttons for at least a predetermined press and hold time period, followed by a manual press of the second one of the two or more receptacle switch buttons within a predetermined time window following the manual press and hold of the first one of the two or more receptacle switch buttons.

11. The smart socket of claim 8, wherein the predetermined sequence of two or more manual presses comprises a manual press of the first one of the two or more receptacle switch buttons followed by another manual press of the first one of the two or more receptacle switch buttons.

12. A smart socket comprising:
a housing that houses:
one or more socket receptacles each for receiving an electrical plug;
one or more power connections for connecting to a power source;
a power input port for receiving input power from the one or more power connections;
one or more receptacle switches each operatively coupled between the power input port and a corresponding socket receptacle, each receptacle switch, when in a closed position, allows power to pass from the power input port to the corresponding socket receptacle, and when in an open position, does not allow power to pass from the power input port to the corresponding socket receptacle;
one or more receptacle switch buttons accessible from outside of the housing, wherein each of the one or more receptacle switch buttons, when manually pressed by a user causes the corresponding receptible switch to alternately switch between the open position and the closed position;
a wireless communication circuit for wirelessly communicating with a remote device;
a controller operatively coupled to the one or more receptacle switches and the wireless communication circuit, the controller configured to:
receive one or more commands via the wireless communication circuit, including a command that causes the controller to switch one or more of the receptacle switches between the closed position and the open position;
the controller further includes one or more smart socket settings that each can be changed from a default value to a programmed value, wherein the controller references the one or more smart socket settings to control one or more operations of the smart socket; and
the controller configured to monitor manual presses of the one or more receptacle switch buttons, and in response to detecting a predetermined sequence of two or more manual presses of the one or more receptacle switch buttons, resets at least some of the one or more smart socket settings to their corresponding default values.

13. The smart socket of claim 12 further comprising:
one or more lights visible from outside of the housing, each of the one or more lights is associated with a corresponding one of the one or more receptacle switch buttons, and wherein the controller is configured to control the illumination of each of the one or more lights in a manner that confirms each of the manual presses of the predetermined sequence of two or more manual presses.

14. The smart socket of claim 12, wherein the smart socket comprises two or more socket receptacles, two or more receptacle switches, and two or more receptacle switch buttons, wherein the predetermined sequence of two or more manual presses comprises a manual press of a first one of the two or more receptacle switch buttons and a manual press of a second one of the two or more receptacle switch buttons.

15. The smart socket of claim 14, wherein the predetermined sequence of two or more manual presses comprises a manual press of the first one of the two or more receptacle switch buttons followed by a manual press of the second one of the two or more receptacle switch buttons within a predetermined time window following the manual press of the first one of the two or more receptacle switch buttons.

16. The smart socket of claim 14, wherein the predetermined sequence of two or more manual presses comprises a manual press and hold of the first one of the two or more receptacle switch buttons for at least a predetermined press and hold time period, followed by a manual press of the second one of the two or more receptacle switch buttons within a predetermined time window following the manual press and hold of the first one of the two or more receptacle switch buttons.

17. A method for resetting one or more smart socket settings of a smart socket, wherein each of the smart socket settings can be changed from a default value to a programmed value, the smart socket includes two or more socket receptacles each for receiving an electrical plug, two or more power connections for connecting to a power source, a power input port for receiving input power from the one or more power connections, two or more receptacle switches each operatively coupled between the power input port and a corresponding socket receptacle, where each receptacle switch, when in a closed position, allows power to pass from the power input port to the corresponding socket receptacle, and when in an open position, does not allow power to pass from the power input port to the corresponding socket receptacle, the smart socket further includes two or more receptacle switch buttons, wherein each of the two or more receptacle switch buttons, when manually pressed by a user causes the corresponding receptible switch to alternately switch between the open position and the closed position, the method comprising:
monitoring manual presses of the two or more receptacle switch buttons; and
in response to detecting a predetermined sequence of two or more manual presses of the two or more receptacle switch buttons, resetting at least some of one or more smart socket settings to their corresponding default value.

18. The method of claim 17, wherein the predetermined sequence of two or more manual presses comprises a manual press of a first one of the two or more receptacle switch buttons and a manual press of a second one of the two or more receptacle switch buttons.

19. The method claim 18, wherein the predetermined sequence of two or more manual presses comprises a manual press of the first one of the two or more receptacle switch buttons followed by a manual press of the second one of the two or more receptacle switch buttons within a predetermined time window following the manual press of the first one of the two or more receptacle switch buttons.

20. The method of claim 18, wherein the predetermined sequence of two or more manual presses comprises a manual press and hold of the first one of the two or more receptacle switch buttons for at least a predetermined press and hold time period, followed by a manual press of the second one of the two or more receptacle switch buttons within a predetermined time window following the manual press and hold of the first one of the two or more receptacle switch buttons.
